(19) United States
(12) Patent Application Publication
(10) Pub. No.: US 2018/0339542 A1
(43) Pub. Date: Nov. 29, 2018

(54) Stackable Chalk Dispensing Device

(71) Applicant: Crayola, LLC, Easton, PA (US)

(72) Inventors: Christopher P. Orem, Easton, PA (US); John D. McBride, JR., Easton, PA (US)

(21) Appl. No.: 15/989,990

(22) Filed: May 25, 2018

Related U.S. Application Data
(60) Provisional application No. 62/511,090, filed on May 25, 2017.
(60) Provisional application No. 62/574,436, filed on Oct. 19, 2017.

(51) Int. Cl. B43K 23/016; B43K 27/00

(52) U.S. Cl. CPC B43K 23/016; B43K 27/00

(57) ABSTRACT

The technology described herein relates to a stackable chalk dispensing device that allows a user to stack multiple chalk dispensing devices to form a vertical or horizontal stack of chalk dispensing devices. The vertical stack of stackable chalk dispensing devices increases the reach of the chalk dispensing device, for example, allowing a user to use the chalk within the chalk dispensing device closest to a receiving surface that the user wishes to mark with the chalk dispensing device. The horizontal stack allows a user to mark with several chalks at once. Thus, the stackable chalk dispensing devices allow for the vertical or horizontal stacking of chalks, which allows users to have flexibility in how the users want to interact with multiple chalks at once, whether it is to reach the floor from a standing position, or making multiple markings with several chalks simultaneously.

### CROSS-REFERENCE TO RELATED APPLICATIONS

This application, having attorney docket number HALC.272665 and entitled “Stackable Chalk Dispensing Device,” is a Non-provisional application claiming priority to both U.S. Provisional Application No. 62/511,090, filed May 26, 2017, entitled “Stackable Chalk Dispensing Device,” and U.S. Provisional Application No. 62/574,436, filed Oct. 19, 2017, entitled “Stackable Chalk Dispensing Device.” Both of these applications are incorporated by reference in their entireties.

### STATEMENT REGARDING FEDERALLY SPONSORED RESEARCH OR DEVELOPMENT

Not applicable.

### TECHNICAL FIELD

Aspects of the technology described herein relate to a chalk stacker device.

### BACKGROUND

Traditionally, chalk has been used to draw, write, play, and the like, for education as well as entertainment. Despite all the utility and fun it provides, chalk can be messy. Sidewalk chalk, especially, comes in different colors and tends to get on every surface of a user because of the proximity of the user to the receiving surface (e.g., sidewalk) when the chalk is in use. Chalk holders may be available that hold one chalk at a time; however, these still do not fully avoid the messiness of the chalk because a user is still very close to the writing/drawing surface. Or alternatively, a user may want to create designs with multiple colors and/or lines simultaneously. The technology described herein provides solutions to these problems, as hereinafter set forth.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The technology described herein generally relates to a stackable chalk dispensing device.

The technology described herein is directed to a stackable chalk dispensing device and a method of using the stackable chalk dispensing device. The stackable chalk dispensing device, in accordance with aspects herein, generally comprises a housing portion having a first end with a dispenser tip end cap fitted to it and a second end with a receiving end cap fitted to it. In one aspect, a user may want to create chalk art from, for example, an upright position and in another aspect, a user may want to create chalk art with multiple chalks at once. In accordance with aspects herein, a plurality of stackable chalk dispensing devices may be provided, where each of the stackable chalk dispensing devices may be stacked vertically (i.e. on top of each other) and/or horizontally (side-by-side). In other words, although shown as separate embodiments herein, it is contemplated that each stackable chalk dispensing device may be provided with the necessary configuration for making each stackable chalk dispensing device stackable both horizontally and vertically. For the vertical stacking of the stackable chalk dispensing device, the dispenser tip end cap of each stackable chalk dispensing device may be configured to be coupled to a receiving end cap of another stackable chalk dispensing device in such a way that the plurality of stackable chalk dispensing devices (as many as desired by the user) may be interchangeably stacked in any order. For the horizontal stacking of the stackable chalk dispensing device, each dispenser tip end cap and each receiving end cap of each stackable chalk dispensing device in the plurality of stackable chalk dispensing devices may be provided with a slide mechanism where a encasing bracket portion of the slide mechanism may be located on one side of each respective dispenser tip end cap and each respective receiving end cap; and a sliding projection portion may be located on the opposite side of each respective encasing bracket portion. Then, to stack the stackable chalk dispensing devices, the sliding projection portions of a first stackable chalk dispensing device may be slid into the encasing portions of a second stackable chalk dispensing device, and so on, for as many chalk stacking dispensing devices the user may want to have in a horizontal stack and in any order desired. In accordance with aspects herein, each stackable chalk dispensing device may be configured to hold/dispense a chalk piece independently from another chalk dispensing device.

The stackable chalk dispensing devices, in accordance with aspects herein, allow a user to have mess-free chalk play/use for marking on any desired receiving surface by completely encasing the chalk piece with only the exception of the marking tip of the chalk. Additional objects, advantages, and novel features will be set forth, in part, in the description which follows, and in part, will become apparent to those skilled in the art upon examination of the following, or may be learned by practice of the technology described herein.

### BRIEF DESCRIPTION OF THE SEVERAL VIEWS OF THE DRAWINGS

The technology described herein is described in detail below with reference to the attached drawing figures, wherein:

FIG. 1 depicts a perspective view of a user using a stack of stackable chalk dispensing devices in accordance with aspects herein;

FIG. 2A depicts a close up view of a hand of a user using a first stackable chalk dispensing device, in accordance with aspects herein;

FIG. 2B depicts a deconstructed view of the second stackable chalk dispensing device of FIG. 2A, in accordance with aspects herein;

FIG. 2C depicts a deconstructed view of the dispenser tip portion end cap of the first stackable chalk dispensing device of FIG. 2B, in accordance with aspects herein;

FIG. 2D depicts a holding/dispensing mechanism of the first stackable chalk dispensing device of FIG. 2B, in accordance with aspects herein;

FIG. 3A is a perspective internal view of the holding/dispensing mechanism of the first stackable chalk dispensing device, in accordance with aspects herein;

FIG. 3B is a perspective internal view of the holding/dispensing mechanism of the first stackable chalk dispensing device, in accordance with aspects herein;

FIG. 4 depicts a first plurality of stackable chalk dispensing devices, in accordance with aspects herein;

FIGS. 5A-5C depict a first series of stackable chalk dispensing devices being vertically stacked, in accordance with aspects herein;

FIG. 6 depicts a different perspective view of the vertically stacked chalk dispensing devices of FIG. 5C;

FIG. 7A depicts a close up view of a hand of a user using a second vertically stackable chalk dispensing device, in accordance with aspects herein;

FIG. 7B depicts a deconstructed view of the second vertically stackable chalk dispensing device of FIG. 7A, in accordance with aspects herein;

FIG. 7C depicts a deconstructed view of the end cap having a dispenser tip portion of the second vertically stackable chalk dispensing device of FIG. 7B, in accordance with aspects herein;

FIG. 7D depicts a holding/dispensing mechanism of the second vertically stackable chalk dispensing device of FIG. 7B, in accordance with aspects herein;

FIG. 7E depicts a perspective view showing an interior surface of the end cap having the receiving cavity for a dispenser tip portion from the second vertically stackable chalk dispensing device, in accordance with aspects herein;

FIG. 8A is a perspective internal view of the holding/dispensing mechanism of the second vertically stackable chalk dispensing device shown in FIG. 7A, in a holding state, in accordance with aspects herein;

FIG. 8B is a perspective internal view of the holding/dispensing mechanism of the second vertically stackable chalk dispensing device shown in FIG. 7A, in a dispensing state, in accordance with aspects herein;

FIG. 9 depicts a second plurality of stackable chalk dispensing devices, in accordance with aspects herein;

FIGS. 10A-10C depict a second series of vertically stackable chalk dispensing devices being stacked, in accordance with aspects herein;

FIG. 11 depicts a different perspective view of the vertically stacked chalk dispensing devices of FIG. 10C, in accordance with aspects herein;

FIG. 12 depicts a perspective view of a ring portion for the vertically stacked chalk dispensing device, in accordance with aspects herein;

FIG. 13A depicts a perspective view of a first dispenser tip portion and end cap with ridges, in accordance with aspects herein;

FIG. 13B depicts a perspective view of a second dispenser tip portion and end cap with one or more threading elements, in accordance with aspects herein;

FIG. 14A depicts a close up view of a hand of a user using a stack of horizontally stackable chalk dispensing devices, in accordance with aspects herein;

FIG. 14B depicts how the stackable chalk dispensing device can be stacked horizontally, in accordance with aspects herein;

FIG. 15A-15D depict frontal views of the different sides of an horizontally stackable chalk dispensing device in accordance with aspects herein;

FIG. 16A depicts a deconstructed view of the horizontally stackable chalk dispensing device in accordance with aspects herein;

FIG. 16B depicts a deconstructed view of the dispenser tip portion end cap of the horizontally stackable chalk dispensing device of FIG. 16A, in accordance with aspects herein;

FIG. 16C depicts a holding/dispensing mechanism of the horizontally stackable chalk dispensing device of FIG. 16B, in accordance with aspects herein;

FIG. 17 depicts a perspective view of a ring portion for the horizontally stacked chalk dispensing device, in accordance with aspects herein;

FIG. 18 depicts a perspective view of an end cap with a holding/dispensing mechanism for a horizontally stackable chalk dispensing device, in accordance with aspects herein; and

FIG. 19 depicts a method of assembling the stackable chalk dispensing devices, in accordance with aspects herein.

### DETAILED DESCRIPTION

The stackable chalk dispensing devices in accordance with aspects herein generally comprise a housing portion having a first terminal portion and a second terminal portion. Further, the stackable chalk dispensing device comprises a first end cap with a receiving cavity fitted to one of the first terminal portion or the second terminal portion of the housing portion, and a second end cap with a chalk holding/dispensing mechanism and a chalk dispenser tip portion fitted to the other of the first terminal portion or the second terminal portion. As briefly described above, the stackable chalk dispensing devices may be horizontally and/or vertically stacked. For the vertically stacking chalk stacking devices in accordance with aspects herein, there may be several different ways that the stackable chalk dispensing devices may be vertically stacked and fitted together so that they can remain vertically stacked until physically taken apart. For example, the dispenser tip portions of the stackable chalk dispensing devices in accordance with aspects herein may comprise a plurality of ridges on their external surfaces. The plurality of ridges may allow the dispenser tip portion of, for example, one stackable chalk dispensing device to fit securely into the first end cap of another stackable chalk dispensing device, and also allow for the dispenser tip portion to be removed from the first end cap with minimal effort by effectively reducing a contact surface area between the exterior surface of the dispenser tip portion of the one stackable chalk dispensing device and an interior surface (i.e., a smooth and even surface) of the first end cap enclosing the receiving cavity of the other stackable chalk dispensing device. As such, several stackable chalk dispensing devices may be vertically stacked together by simply snapping them together and pulling them apart at will.

Another way to securely stack multiple stackable chalk dispensing devices vertically may include, for example, providing one or more threading elements on the outer surface of the dispenser tip portions of the stackable chalk dispensing devices in accordance with aspects herein. As well, the first end caps with the receiving cavities of the vertically stackable chalk dispensing devices may be equipped with one or more complementary threading elements on their interior surfaces to receive and secure the dispenser tip portions by a simple twisting motion and to pull apart by a simple untwisting motion.

A feature of the vertically and/or horizontally stackable chalk dispensing devices in accordance with aspects herein is that each stackable chalk dispensing device is configured to hold/dispense a chalk piece provided within, whether there are two or more stackable chalk dispensing devices stacked together, or whether the stackable chalk dispensing devices are not stacked together. In other words, the stackable chalk dispensing devices, in accordance with aspects herein, may be stacked together whether loaded with a chalk piece or not.

As briefly mentioned above, each of the vertically and/or horizontally stackable chalk dispensing devices may comprise a holding/dispensing mechanism that is configured to hold the chalk in place or to dispense the chalk so that a user may use the chalk to create markings on a receiving surface. In other words, when there is a sufficient amount of chalk exposed so that it is useable, the holding/dispensing mechanism is configured to hold the chalk in place and when there is not enough chalk exposed, the holding/dispensing mechanism is configured to release the chalk provided within so that more of the chalk can become exposed. Because the stackable chalk dispensing devices in accordance with aspects herein need to be able to stack on top of each other and/or side by side, the holding/dispensing mechanism of each stackable chalk dispensing device may be provided on one side as opposed to on top.

The holding/dispensing mechanism may be provided at any location along the length of the stackable chalk dispensing devices herein. For example, the holding/dispensing mechanism may be located at any position along the length of the housing portion of the stackable chalk dispensing device, or as shown, the holding/dispensing mechanism may be located at one of the end caps that are fitted to the housing portion of the stackable chalk dispensing device. The holding/dispensing mechanism may be spring-loaded so that a chalk provided within the stackable chalk dispensing device may be reversibly either held in place when enough of the chalk is exposed and available for marking, or dispensed from the stackable chalk dispensing device by using the inherent properties of a spring. For instance, when a spring is expanded, the spring is in its rest position, and when the spring is contracted, it is in its active position as it is storing the energy that was required to force the spring into its contracted state.

The holding/dispensing mechanism in accordance with aspects herein may be configured to circumferentially tighten a grip on a chalk piece disposed within a cavity of the stackable chalk dispensing device. This may be achieved, for example, by providing a ring portion that may generally comprise an internal diameter/perimeter that may be equal to or slightly bigger than an interior diameter/perimeter of the dispenser tip portion of the second end cap. In general, an internal diameter/perimeter of the dispenser tip portion may be smaller than the internal diameter/perimeter of the housing portion and a sheltering portion of the second end cap. The external surface of the ring portion may be provided with a tab portion. The tab portion may be an integral part of the ring portion, or may be a separate piece that is fitted to or affixed to the ring portion. The tab portion may be configured to extend through an opening in the sheltering portion of the second end cap so that while the ring portion may be sheltered inside of the second end cap, the tab portion may protrude and be exposed through the opening of the sheltering portion of the second end cap.

The inner surface of the second end cap that is directly opposite to the tab portion of the ring portion may be provided with a spring that may be configured to be in direct contact with the ring portion. The spring portion may be secured to or simply aligned with the ring portion so that when the tab portion is not pushed in by a user, the ring portion may be pushed by the spring to make the tab portion protrude out of the sheltering portion of second end cap through the opening. Further, when the spring is pushing the ring portion so that the tab is protruding, this configuration may cause a misalignment of the interior diameter/perimeter of the ring portion and the interior diameter/perimeter of the dispenser tip portion. Therefore, when a chalk piece is provided within the stackable chalk dispensing device, the chalk piece may become tightly gripped by the ring portion and at least a portion of the interior surface of the sheltering portion of the second end cap. Alternatively, when a user pushes the tab portion in, the force exerted by the user may cause the spring to become contracted as it is pushed by the ring portion, thereby allowing the interior diameter/perimeter of the dispenser tip portion and the interior diameter/perimeter of the ring portion to align so that the chalk piece can “fall” through to be dispensed.

When a user is ready to use the stackable chalk dispensing device(s) described herein, the user may be provided with one or more chalk pieces and at least two stackable chalk dispensing devices. The user may then take one of the stackable chalk dispensing devices and insert a chalk piece into the housing portion of each of the stackable chalk dispensing devices through their respective tip dispenser portion by keeping the tab portion of the holding/dispensing mechanism pressed so that the stackable chalk dispensing device is in its dispensing configuration, and thus, the chalk piece is able to slide in effortlessly. Otherwise, the chalk piece may also be inserted through a respective cavity in the first end cap portion that is opposite to the dispenser tip portion at the opposite end. Once a desired amount of chalk is left exposed for writing/drawing/marking, the tab portion may be released by the user so that the chalk piece becomes secured in place and is no longer allowed to slide freely within the housing portion. If the user desired to lengthen the reach of the stackable chalk dispensing device or if they user desired to use two or more chalks at once, the user may choose to stack another stackable chalk dispensing device to the stackable chalk dispensing device in use by securing the dispenser tip portion of the other stackable chalk dispensing device to the first end cap portion of the stackable chalk dispensing device in use for forming a vertical stack, or the user may form a horizontal stack, by laterally securing one chalk dispensing device to another. The second stackable chalk dispensing device may optionally be provided with its own chalk piece disposed within so that it is readily accessible to the user when needed. In other words, the stackable chalk dispensing devices in accordance with aspects herein may be stackable regardless of whether there are chalk pieces housed within them or not. Further, the number of stackable chalk dispensing devices that may be stacked may only be limited by the number of stackable chalk dispensing devices provided to the user. In other words, the user may stack two, three, four, five, or any number of stackable chalk dispensing devices, as desired. When an exposed portion of the chalk piece becomes used up, the user may release the chalk piece from the grip of the holding/dispensing mechanism of the stackable chalk dispensing device in use (i.e., closest to the writing surface) until a desired amount of the chalk piece becomes exposed for using, by pressing on the tab portion of the holding/dispensing mechanism of the stackable chalk dispensing device in use. Then, once a desired amount of chalk becomes exposed for writing, the user may release the tab portion and use the stacked stackable chalk dispensing device once again. The stackable chalk dispensing devices may have any cross-sectional shape suitable for aspects herein, such as, circular (as shown in figures), square (as shown in figures), rectangular, triangular, hexagonal, and the like. Further, although the figures show the vertically stacking stackable chalk dispensing devices separately from the horizontally stacking stackable chalk dispensing devices for clarity and ease of understanding, it is also contemplated that one set of stackable chalk dispensing devices may be both vertically stackable and horizontally stackable by combining the stackable properties described for both the vertically stackable and the horizontally stackable chalk dispensing devices.

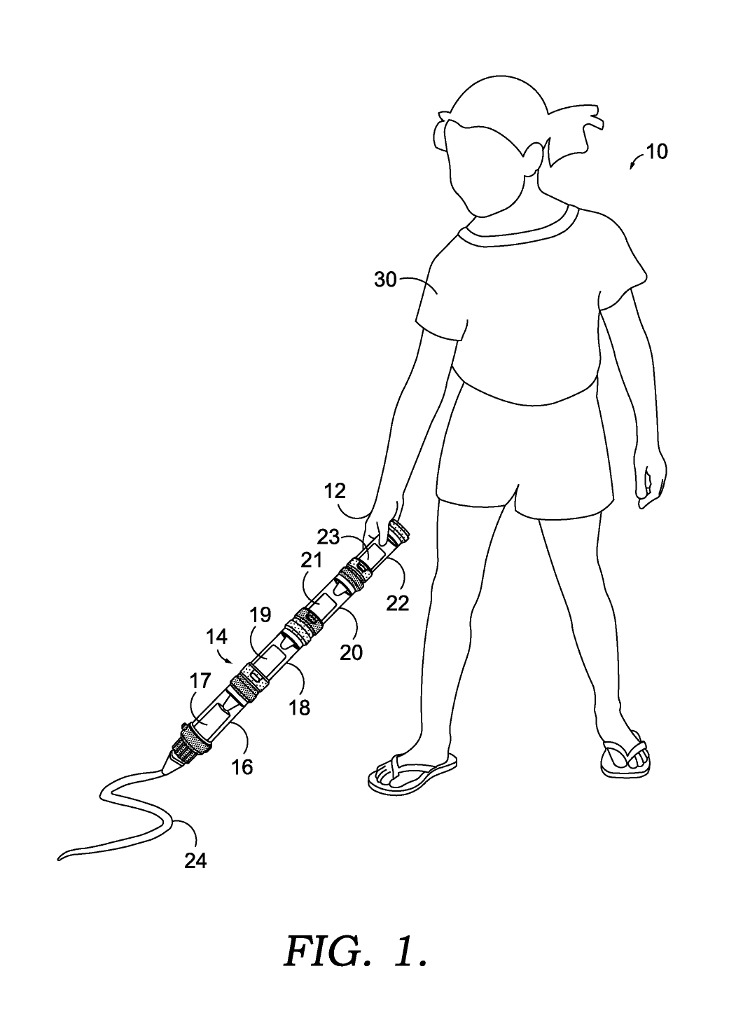

Aspects of the technology described herein will become more apparent with reference to the figures provided herein. Turning now to FIG. 1, FIG. 1 depicts a perspective view of a user 10 using a vertical stack 14 of the vertically stackable chalk dispensing devices 16, 18, 20, 22, in accordance with aspects herein, to make a chalk mark 24 on a receiving surface (not shown). Each vertically stackable chalk dispensing device 16, 18, 20, and 22, may be provided with a different color chalk (e.g., 17, 19, 21, and 23), and if the user 10 desires to switch to another color, all the user 10 has to do is uncouple the bottom vertically stackable chalk dispensing device 16 (i.e., the stackable chalk dispensing device housing portion holding the chalk piece that was last used) and optionally couple it to the last (i.e., top most) vertically stackable chalk dispensing device 22, as described above. As such, when using the vertically stackable chalk dispensing devices 16, 18, 20, and 22, for example, the user 10 may be able to carry multiple chalk pieces (e.g., 17, 19, 21, and 23) simultaneously, i.e., when all the provided stackable chalk dispensing devices 16, 18, 20, and 22 in the vertical stack 14 are each provided with their own respective chalk piece. Further, when using the stackable chalk dispensing devices (e.g., 16, 18, 20, and 22) the user 10 is provided with a less messy chalk experience because the stackable chalk dispensing devices (e.g., 16, 18, 20, and 22) may minimize the direct contact of the user with the chalk pieces, thereby avoiding or minimizing getting chalk powder on the user's hands 12 and/or clothes 30. Furthermore, in the case of sidewalk chalk (e.g., 17, 19, 21, and 23), the length that may be provided by vertically stacking two or more of the stackable chalk dispensing devices (i.e., 16, 18, 20, and 22) may also provide an easier user experience because the user 10 may be given the ability to make chalk markings 24 on the floor without having to sit, kneel and/or bend over the floor. In other words, the user 10 may be able to make chalk markings 24 on the floor from an upright sitting position or even a standing position (as shown). Further, the user 10 may be able to easily walk while making chalk markings 24 on the floor, thereby providing the user 10 with the ability to draw large designs on the floor with less effort and an improved perspective view from above.

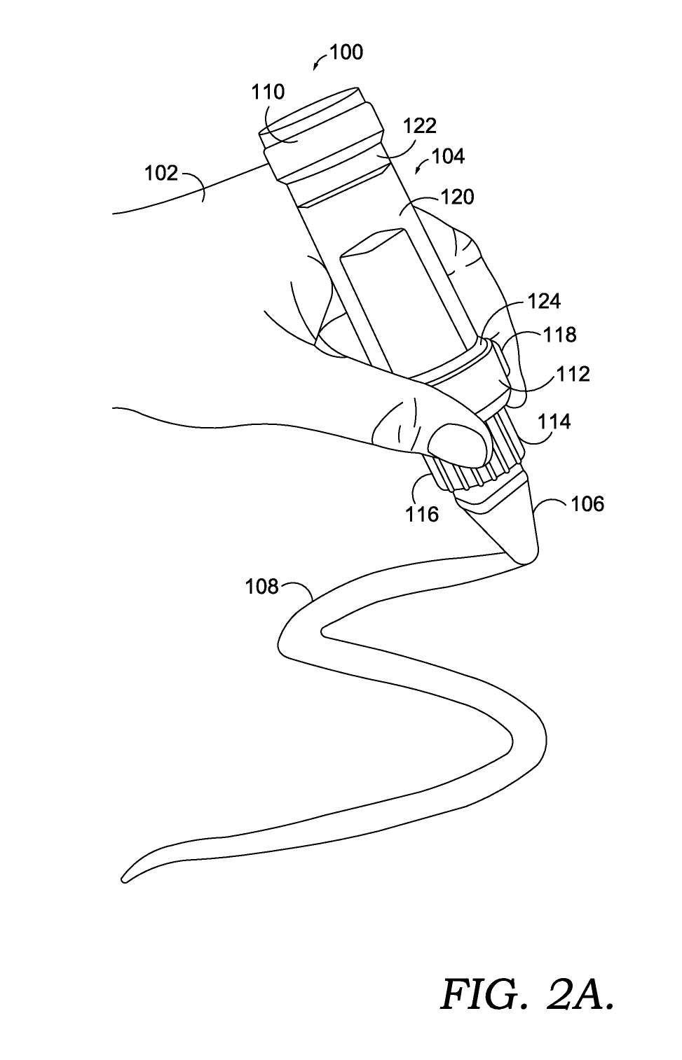

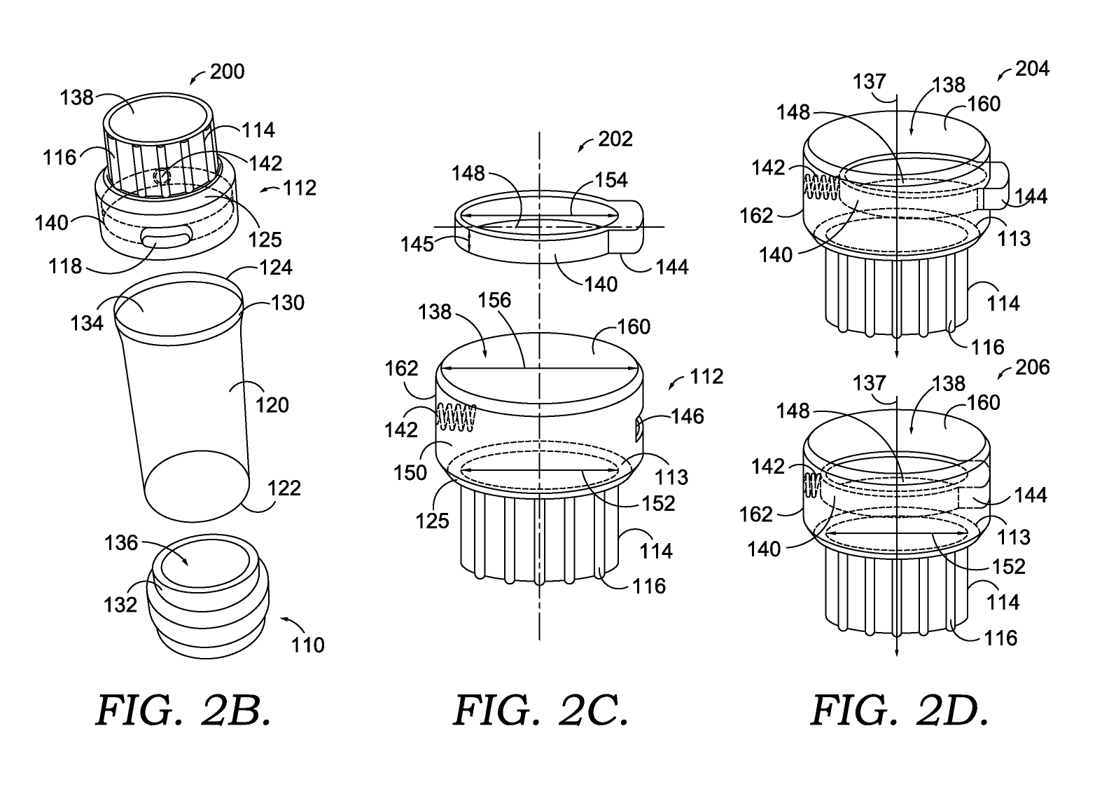

As can be seen in FIG. 1, the vertically stackable chalk dispensing device 16 is closer to the receiving surface, and therefore, the chalk piece 17 provided within the cavity of the vertically stackable chalk dispensing device 16 is used for making the chalk mark 24. Since the vertically stackable chalk dispensing device 22 is at the end of the vertical stack 14, the user 10 is able to hold the vertical stack 14 in the user's hand 12 by the vertically stackable chalk dispensing device 22 in order to guide the vertical stack 14 as the user 10 makes chalk mark 24 on the receiving surface, from a standing position. In other words, the vertically stackable chalk dispensing device in accordance with aspects herein allows the user 10 to effectively lengthen a stackable chalk dispensing device and therefore provide a longer reach, and thereby a more comfortable and cleaner chalk drawing/writing/marking activity for the user 10. Further, as described above, the user 10 is given the ability to carry multiple chalk pieces 17, 19, 21, and 23 at once by, for example, providing a chalk piece (e.g., 17, 19, 21, and 23) within a cavity of each of the vertically stackable chalk dispensing devices 16, 18, 20, and 22, respectively, provided to the user 10. The user 10 may then interchangeably use the different chalk pieces 17, 19, 21, and 23 provided, by simply changing the order of the vertically stackable chalk dispensing devices 16, 18, 20, 22 in the vertical stack 14. However, it is to be noted that the stackable chalk dispensing devices (e.g., 16, 18, 20, and 22), although being described as stacked, can also be used one by one to avoid direct contact with a chalk piece (e.g., 17, 19, 21, and 23) contained within, as further shown in FIG. 2A.

FIG. 2A depicts a close up view 100 of a hand of a user 102 using a single stackable chalk dispensing device 104 in accordance with aspects herein, having a chalk piece 106 provided within that is useable to make mark 108 when in use. The stackable chalk dispensing device 104 generally comprises a housing portion 120 for optionally housing a chalk piece, such as chalk piece 106; and a first end cap 110 fitted to a first end 122 of the housing portion 120 that is configured to receive and secure a dispenser tip of another stackable chalk dispensing device (not shown) when two or more stackable chalk dispensing devices are provided and stacked. Further, the stackable chalk dispensing device 104 comprises a second end cap 112 fitted to a second end 124 of the housing portion 120. The second end cap 112 comprises a dispenser tip portion 114 and is configured to shelter a holding/dispensing mechanism 118 within the second end cap 112. The dispenser tip portion 114, in accordance herein, may comprise a plurality of ridges 116 that aid in securely fitting the dispenser tip portion 114 into a receiving cavity of another stackable chalk dispensing device (not shown) when two or more stackable chalk dispensing devices are provided and stacked. The plurality of ridges 116 may, in one aspect, create a secure seal between an interior surface of the first end cap of another stackable chalk dispensing device defining a receiving cavity and the dispenser tip portion, in order for a user to be able to safely and effectively use, for example, a vertical stack 14 of vertically stacked chalk dispensing devices 16, 18, 20, and 22, as shown in FIG. 1. In another aspect, the plurality of ridges 116 may prevent the dispenser tip portion 114 from forming a semi-permanent seal with the interior surface of the first end cap of another stackable chalk dispensing device defining its receiving cavity. In other words, this prevents a semi-permanent bond between the dispenser tip portion 114 and the interior surface of the first end cap of the other stackable chalk dispensing device that would require a force beyond a person's (e.g., an adult or child) ability to pull the two vertically stackable chalk dispensing devices apart. Said differently, the plurality of ridges 116 may provide breaks in the temporary frictional bond created between the interior surface of the first end cap defining its receiving cavity and dispenser tip portion 114 so that the temporary frictional bond can be broken with reasonable force created when a user pulls the two vertically stackable chalk dispensing devices apart.

FIG. 2B depicts a deconstructed view 200 of the stackable chalk dispensing device 104 depicted in FIG. 2A. As briefly described above, the stackable chalk dispensing device 104 comprises a first end cap 110 having a receiving cavity 136 and a lip portion 132. The lip portion 132 is configured to be fitted with the first end 122 of the housing portion 120. The housing portion 120 also comprises a lip portion 130 at the second end 124 that is configured to be fitted with the second end cap 112. The housing portion 120 is essentially a hollow cylinder having an enclosed cavity 134. The second end cap 112 is configured to shelter a holding/dispensing mechanism 118 between the housing portion 120 and the dispenser tip portion 114. The second end cap 112 also encloses a cavity 138. Thus, when the first end cap 110, the housing portion 120, and the second end cap 112 are assembled together, the cavities 136, 134, and 138 form a single through cavity that allows a chalk piece (not shown) to be inserted, housed, and dispensed through the stackable chalk dispensing device 104, for example, in a direction shown by arrow 137. The dispenser tip portion 114 of the chalk dispensing device, in accordance with aspects herein, comprises a plurality of ridges 116 that are configured to secure the stackable chalk dispensing device 104 with another stackable chalk dispensing device by, for instance, pushing the dispenser tip portion 114 into the receiving cavity of the other stackable chalk dispensing device.

FIG. 2C depicts a deconstructed view 202 of the second end cap 112 having the dispenser tip portion 114 and housing the holding/dispensing mechanism 118 shown in FIGS. 2A and 2B. As shown, the holding/dispensing mechanism 118 is comprised of at least a ring portion 140 and a spring 142. The ring portion 140 may be fitted with a tab portion 144, or the tab portion 144 may be integrally formed with the ring portion 140 as a single piece. The ring portion 140 may be formed from a rigid or semi-rigid material, and the tab portion 144 may be configured to extend through an opening 146 formed in the sheltering portion 150 of the second end cap 112. The sheltering portion 150 may be provided with a spring 142 at a location that is opposite to the opening 146. The ring portion 140 encloses an opening 148 that may have an interior diameter/perimeter 154 that is the same or close in size (slightly larger than the interior diameter/perimeter 152 but smaller than interior diameter/perimeter 156 of the sheltering portion 150 to provide a working space for the spring 142 when the ring portion 140 is disposed within the sheltering portion 150 with tab portion 144 extended through opening 146 of the sheltering portion 150 of the second end cap 112). Although not shown, for simplicity's sake, a receiving groove may be provided on an interior surface of the sheltering portion 150 to sustain the ring portion 140 in place and that stabilizes it in the Y-direction while it is able to slide back and forth in the X-direction. Alternatively, the transitioning point 125 between sheltering portion 150 and dispenser tip portion 114 on one end, and the lip portion 130 of the housing portion 120 (when fitted with the second end cap 112) may together serve to stabilize the ring portion 140. Thus, a width 145 of the ring portion 140 may be adjusted accordingly to securely accommodate the ring portion 140 in the sheltering portion 150 of the second end cap 112, in the Y-direction.

FIG. 2D depicts the holding/dispensing mechanism 118, as shown in FIGS. 2A and 2B, of the stackable chalk dispensing device 104 in action. For example, the perspective view 204 shows the holding configuration for the holding/dispensing mechanism 118, and the perspective view 206 shows the dispensing configuration for the holding/dispensing mechanism 118. As seen from the perspective view 204, when the holding/dispensing mechanism 118 is in its holding configuration, the spring 142 is in its relaxed state (stretched) and is configured to push the ring portion 140 so that the ring portion 140 becomes pushed against the interior surface 160 of the sheltering portion 150 of the second end cap 112. Consequently, the tab portion 144 becomes exposed and is configured to protrude beyond the external surface 162 of the sheltering portion 150 of the second end cap 112. As well, the through opening 148 through the second end cap 112 becomes constricted, and therefore, it exerts a holding force on a chalk piece (not shown) inserted into the stackable chalk dispensing device 104 in accordance with aspects herein. Alternatively, when the holding/dispensing mechanism 118 is in its dispensing configuration as shown in the perspective view 206, a user pushes on the tab portion 144. The pushing force essentially causes the ring portion 140 to push against the spring 142, causing it to contract and store the energy from the push. As well, the push on the tab portion 144 causes the through opening 148 of the ring portion 140 and the interior diameter/perimeter 152 of the dispenser tip portion 114 to align and therefore release the chalk piece inserted into the stackable chalk dispensing device 104 so that the chalk piece is able to sufficiently slide out of the stackable chalk dispensing device 104 so that it becomes exposed and ready for use.

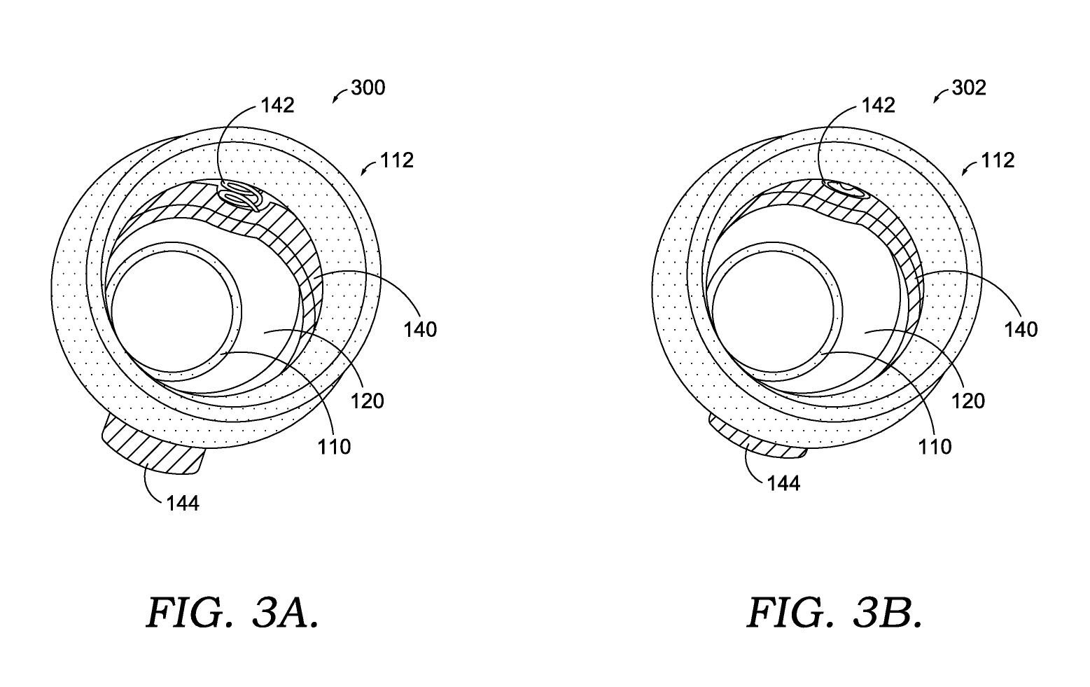

FIG. 3A is a perspective internal view 300 of the stackable chalk dispensing device 104 looking in through the second end cap 112 in its holding configuration. As discussed above, when in its holding configuration, the spring 142 is in its relaxed state and is pushing the ring portion 140 so that the tab portion 144 is protruding out of the sheltering portion 150 of the second end cap 112. FIG. 3B, on the other hand, shows a perspective internal view 302 of the stackable chalk dispensing device 104 looking in through the second end cap 112 and in its dispensing configuration. As discussed above, when in its dispensing configuration, the spring 142 is in its active/loaded state (compressed) when a user is pushing in on the tab portion 144. Once the user releases the tab portion 144, the spring 142 pushes back on the ring portion 140, releasing its stored energy, and therefore, the tab portion 144 is also returned to its protruding state.

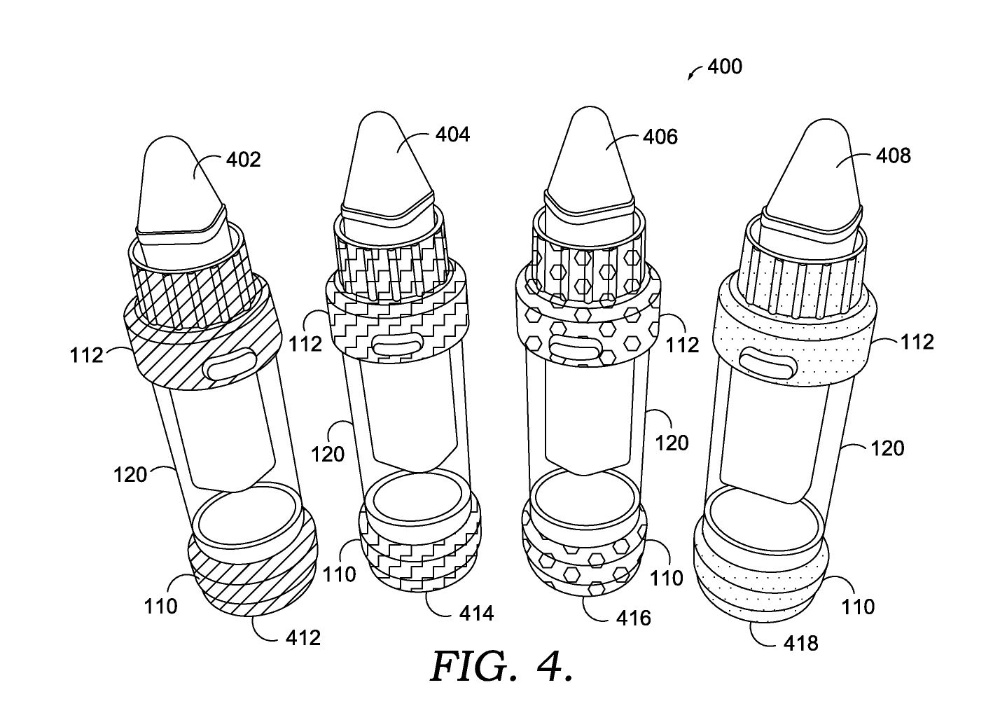

FIG. 4 depicts a plurality of stackable chalk dispensing devices 400, in accordance with aspects herein. As shown, a user may be provided with one, two, three, four, or more stackable chalk dispensing devices 400. The housing portion 120 of each stackable chalk dispensing device 412, 414, 416, and 418, for example, may comprise a chalk piece 402, 404, 406, and 408, respectively disposed within an interior cavity of each stackable chalk dispensing device 412, 414, 416, and 418, with a sufficient amount of the chalk piece being exposed for writing/marking. However, the chalk piece is not necessary for the stackable chalk dispensing devices 412, 414, 416, and 418 to be stacked, for example, vertically. In another aspect, because of the clear or see-through nature of the housing portion 120, a user may be able to easily recognize whether there is a chalk piece provided inside one or more of the stackable chalk dispensing devices 412, 414, 416, and 418, and in the case of colored chalk, a user may be able to readily discern the color of the chalk and make a choice of color quickly. Additionally, the first end cap 110 and the second end cap 112 of each of the stackable chalk dispensing devices 412, 414, 416, and 418 may be the same color, or alternatively, they may comprise different colors to further differentiate each stackable chalk dispensing device 412, 414, 416, and 418 from another (as shown).

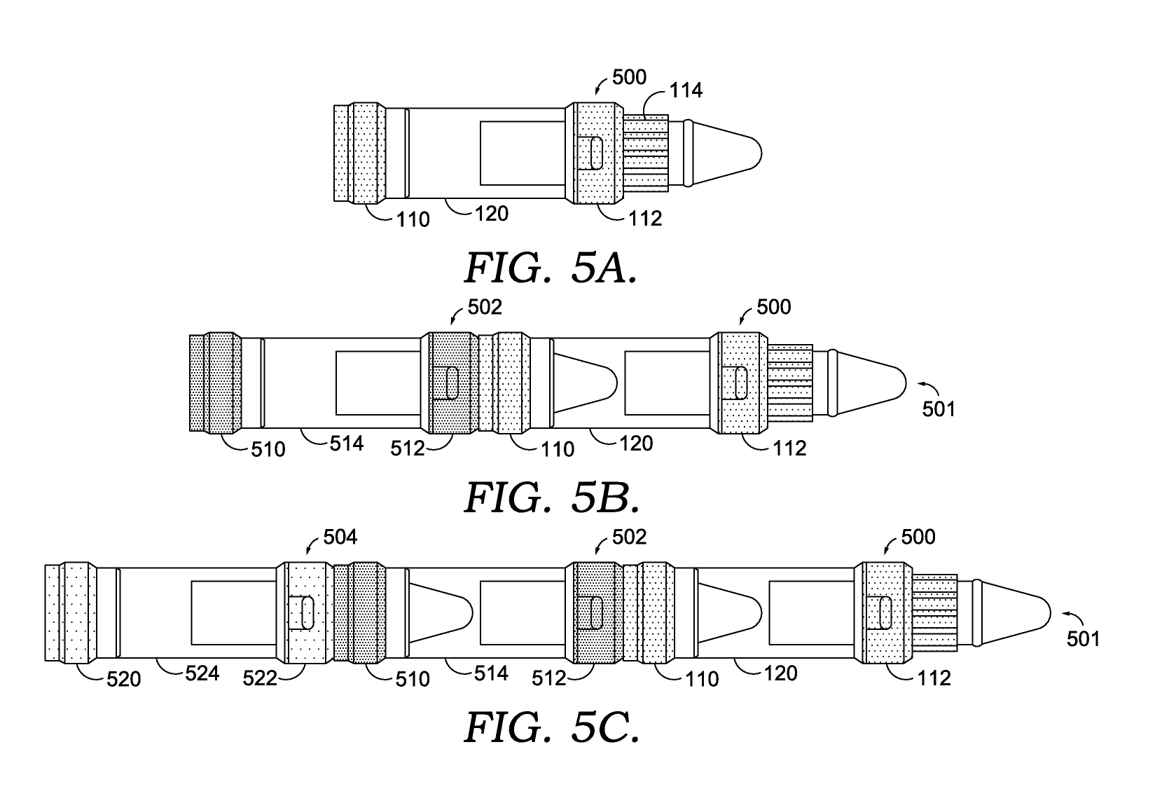

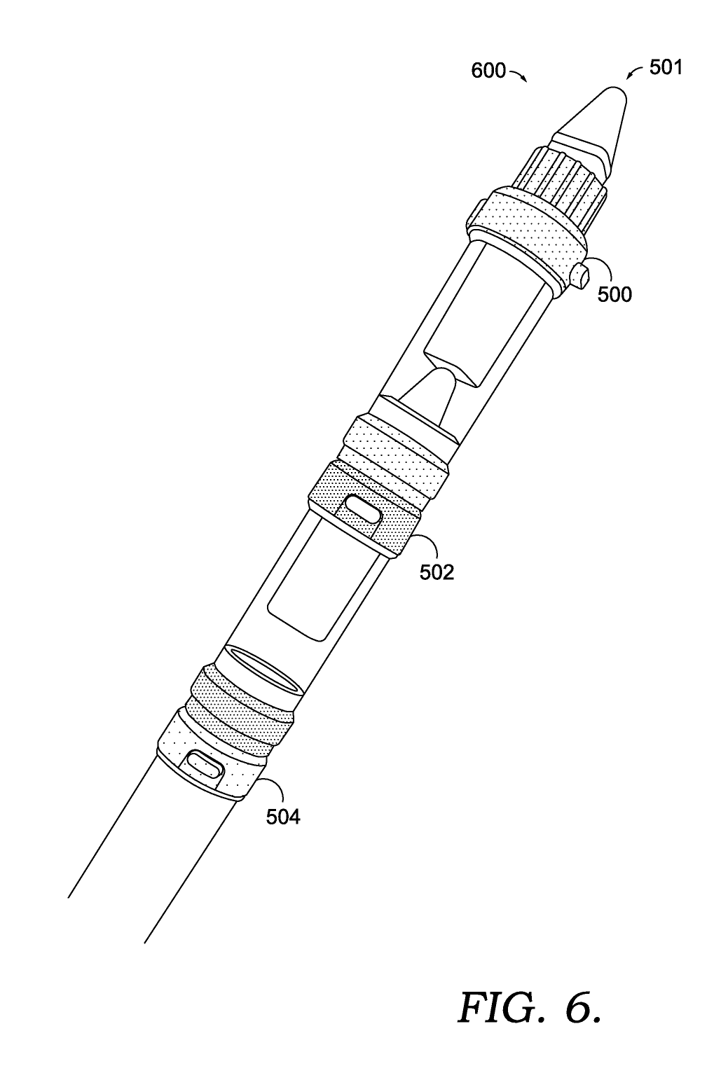

FIGS. 5A-5C depict a series of stackable chalk dispensing devices being stacked vertically, in accordance with aspects herein. For instance, stackable chalk dispensing device 500 shown in FIG. 5A, as described above with respect to stackable chalk dispensing device 104 above, comprises a first end cap 110, a second end cap 112, and a housing portion 120. FIG. 5B shows two stacked stackable chalk dispensing devices 500 and 502 to form vertical stack 501. The basic construction of stackable chalk dispensing device 502, as shown in FIG. 5B, is the same as the basic construction of stackable chalk dispensing device 500 with a first end cap 510, a second end cap 512, and a housing portion 514. As shown, when vertically stacked, the tip portion (not shown) of the second end cap 512 of the stackable chalk dispensing device 502 is inserted into the receiving cavity (not shown) of the first end cap 110 of the first stackable chalk dispensing device 500. Further, FIG. 5C depicts three stackable chalk dispensing devices 500, 502, and 504, as stacked. A user may choose to add an additional stackable chalk dispensing device 504 to the vertical stack 501 shown in FIG. 5B. Since the construction of stackable chalk dispensing device 504 is the same as stackable chalk dispensing devices 500 and 502 with a first end cap 520, a second end cap 522, and a housing portion 524, a dispenser tip (not shown) of the second end cap 522 of the third stackable chalk dispensing device 504 may be inserted into the receiving cavity (not shown) of the first end cap 510 of stackable chalk dispensing device 502. As it can be deduced, the vertical stack 501 may be expanded by further stacking of additional stackable chalk dispensing devices in a similar fashion. FIG. 6 offers a different perspective view 600 of the vertical stack 501 depicted in FIG. 5C.

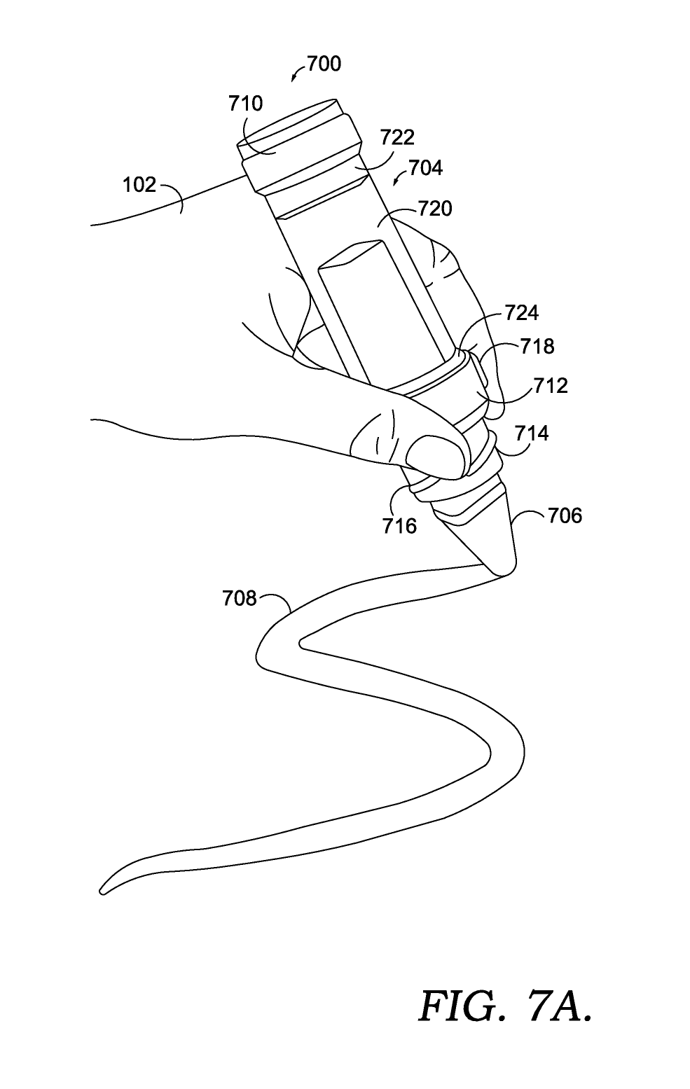

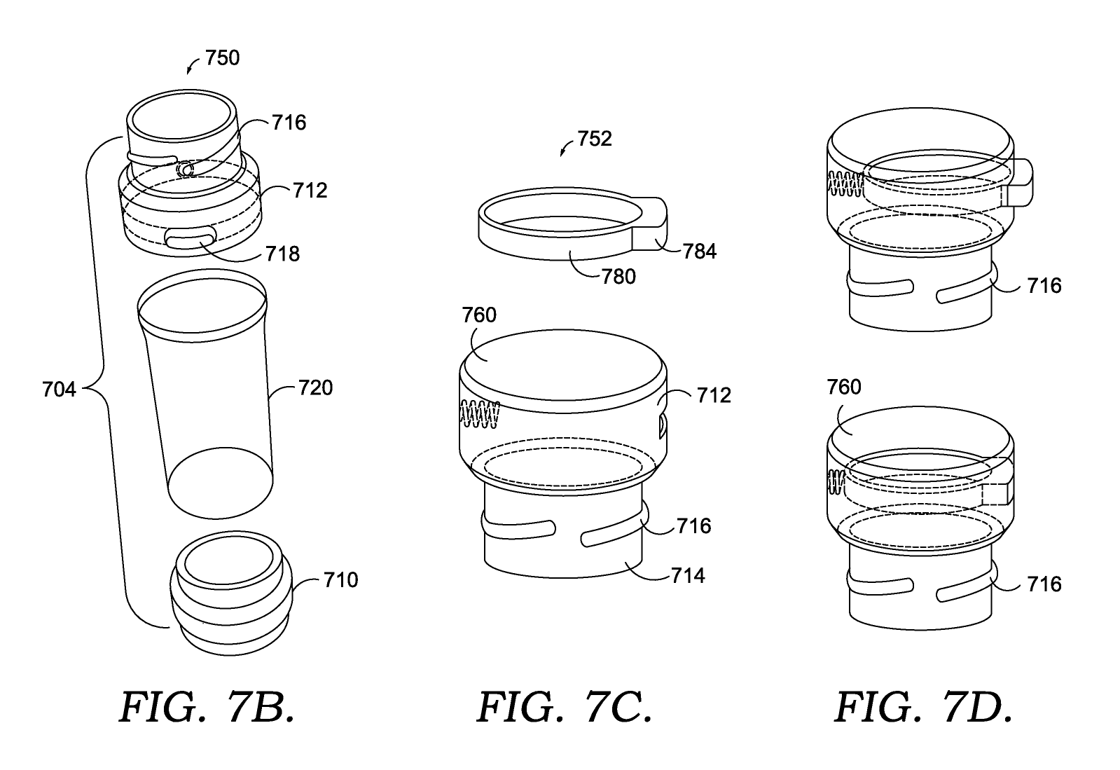

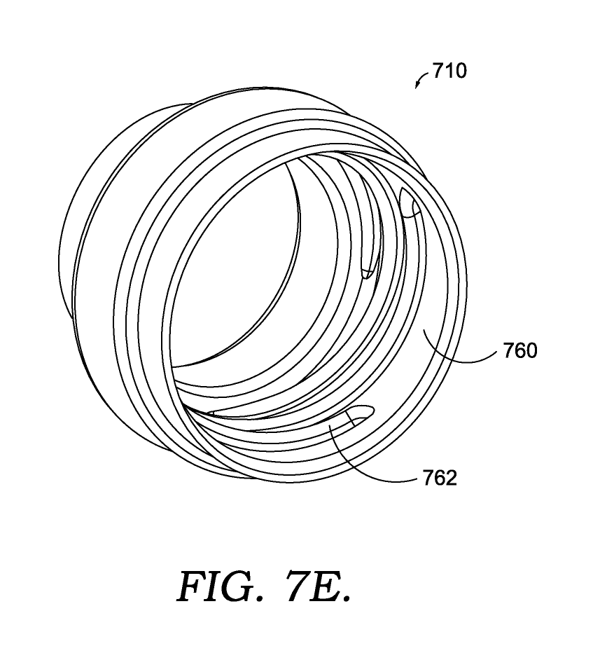

FIG. 7A depicts a close up view 700 of a hand of a user 102 using an alternative stackable chalk dispensing device 704, in accordance with aspects herein, having a chalk piece 706 provided within that is useable to make mark 708 when in use. The stackable chalk dispensing device 704 generally comprises a housing portion 720 for optionally housing a chalk piece such as chalk piece 706, a first end cap 710 fitted to a first end 722 of the housing portion 720, that is configured to receive and secure a dispenser tip of another stackable chalk dispensing device (not shown) when two or more stackable chalk dispensing devices are provided and stacked. Further, the stackable chalk dispensing device 704 comprises a second end cap 712 fitted to a second end 724 of the housing portion 720. The second end cap 712 comprising a dispenser tip portion 714 and being configured to shelter a holding/dispensing mechanism 718 within the second end cap 712. The dispenser tip portion 714, in accordance herein, may comprise one or more threading elements that aid in securely fitting the dispenser tip portion 714 into a receiving cavity of another stackable chalk dispensing device (not shown) when two or more stackable chalk dispensing devices are provided and vertically stacked. The one or more threading elements 716 may, in one aspect, create a secure seal between the first end cap of another stackable chalk dispensing device and the dispenser tip portion 714 by a simple twist action, and a simple untwist action to decouple the first end cap of another stackable chalk dispensing device and the dispenser tip portion 714, when the vertically stacked configuration is no longer needed or no longer wanted.

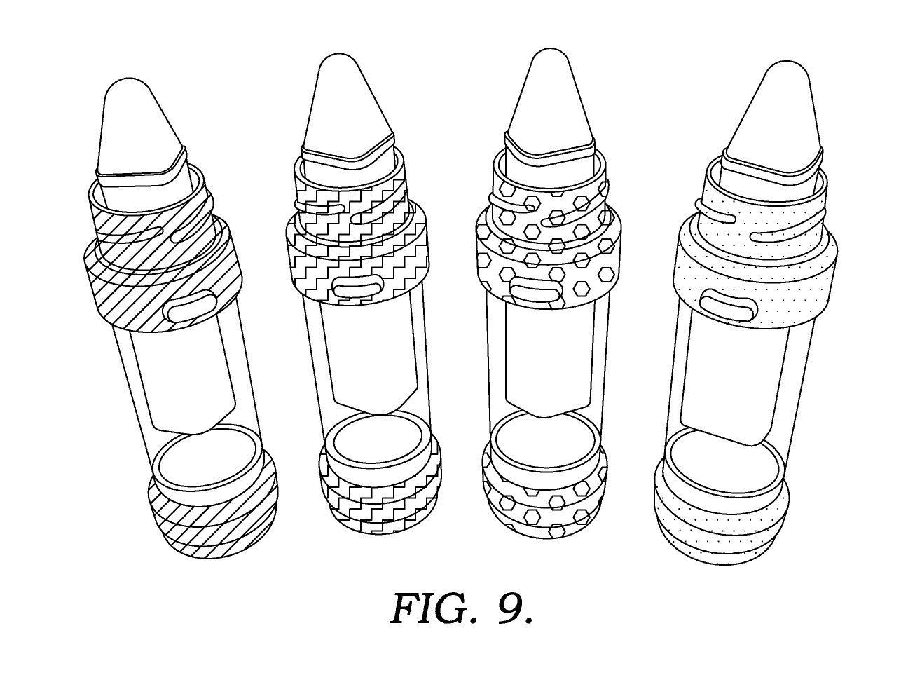

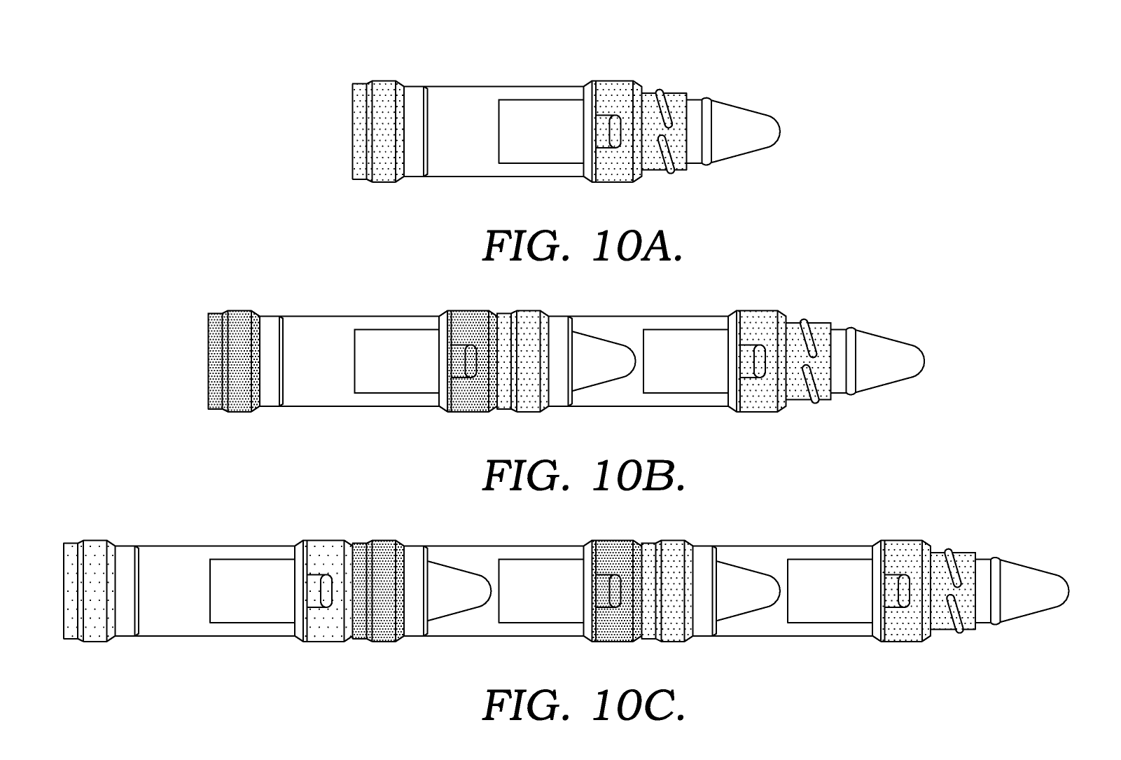

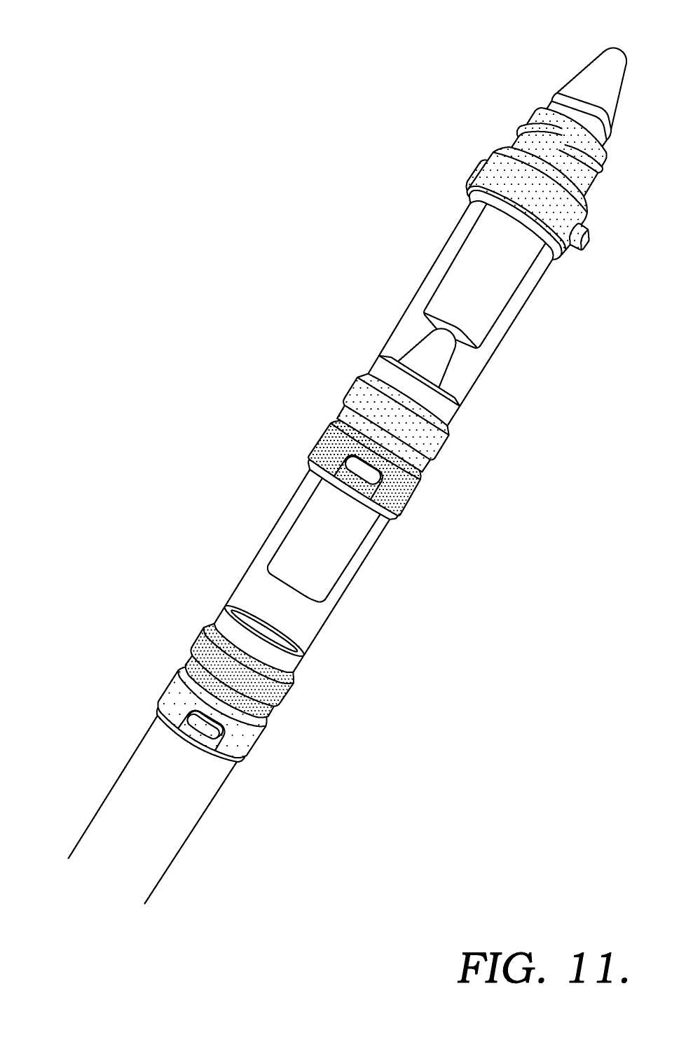

As seen from the deconstructed views 750 and 752 in FIG. 7B and FIG. 7C, respectively, the components of the stackable chalk dispensing device 704 are essentially the same as the stackable chalk dispensing device 104, but for their dispenser tip portions. As briefly described above, instead of a plurality of ridges 116 as on stackable chalk dispensing device 104, the stackable chalk dispensing device 704 comprises one or more threading elements 716. FIGS. 7A-7D show how the housing portion 720 and, in particular, the holding/dispensing mechanism 718 of stackable chalk dispensing device 704 are essentially the same as the holding/dispensing mechanism 118 and the housing portion 120 of the stackable chalk dispensing device 104, as shown in FIGS. 2B to 2D. FIG. 7E, on the other hand, shows a perspective view of an interior surface 760 of the first end cap 710. Because the dispenser tip portion 714 in this example comprises one or more threading elements 716, the first end cap 710 is shown as having one or more complementary threading elements 762 on the interior surface 760 of the first end cap 710, where the dispenser tip portion 714 is to be inserted. The complementary threading elements 762 effectively lock the two or more stackable chalk dispensing devices in a vertical stack, as shown in FIGS. 10B-11, by a simple twist action, or undo the vertical stack by a simple untwist action to provide a plurality of separate stackable chalk dispensing devices, as shown in FIG. 9. In other words, the stackable chalk dispensing devices in accordance with FIGS. 7A-7E essentially function in the same manner as the stackable chalk dispensing devices described above with reference to FIGS. 2A-2D, but for the manner in which they are locked in the vertical stack when the stackable chalk dispensing devices are vertically stacked and held in place until a user decides to undo the vertical stack.

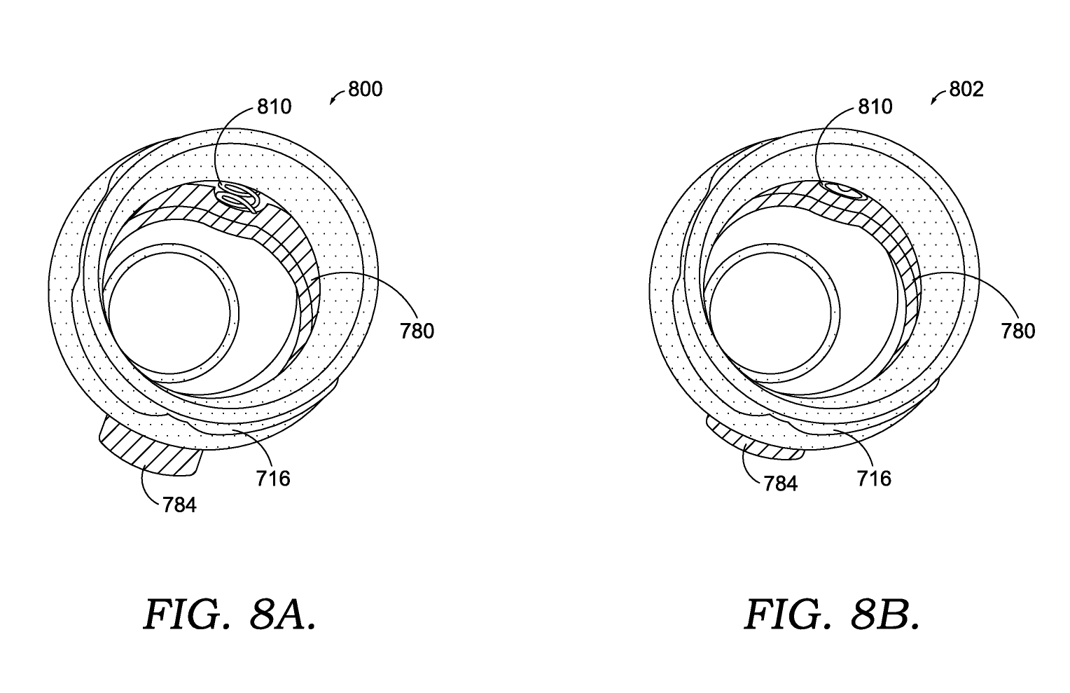

FIG. 8A is a perspective internal view 800 of the stackable chalk dispensing device 704 looking in through the second end cap 712 in its holding configuration. As discussed above, when in its holding configuration, the spring 810 is in its relaxed state and is pushing the ring portion 780 so that the tab portion 784 is protruding out of the sheltering portion of the second end cap 712. FIG. 8B, on the other hand, shows a perspective internal view 802 of the stackable chalk dispensing device 704 looking in through the second end cap 712 in its dispensing configuration. As discussed above, when in its dispensing configuration, the spring 810 is in its active/loaded state (compressed) when a user is pushing in on the tab portion 784. Once the user releases the tab portion 784, the spring 810 pushes back on the ring portion 780, releasing its stored energy, and therefore, the tab portion 784 is also returned to its protruding state.

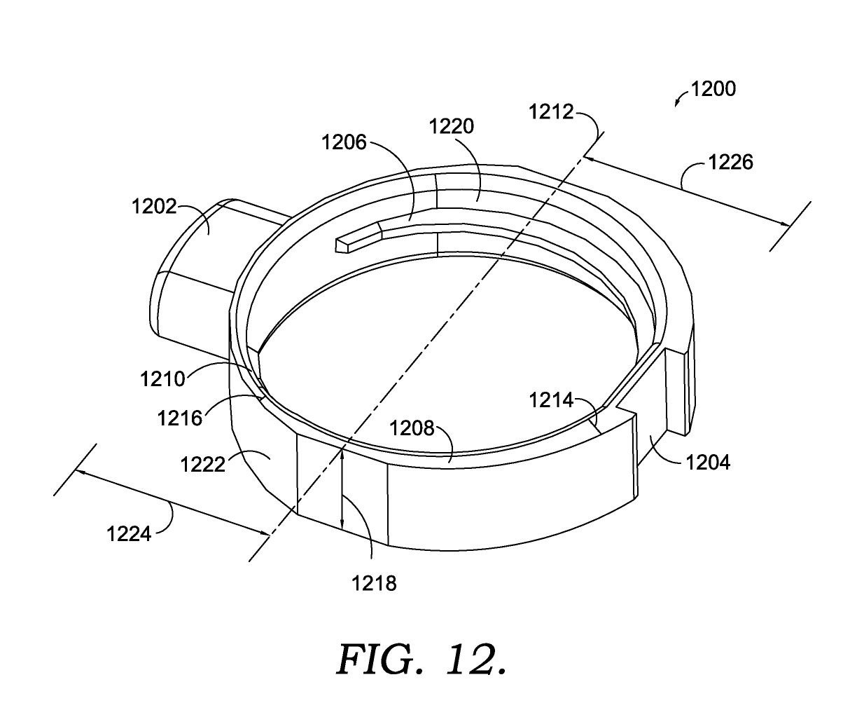

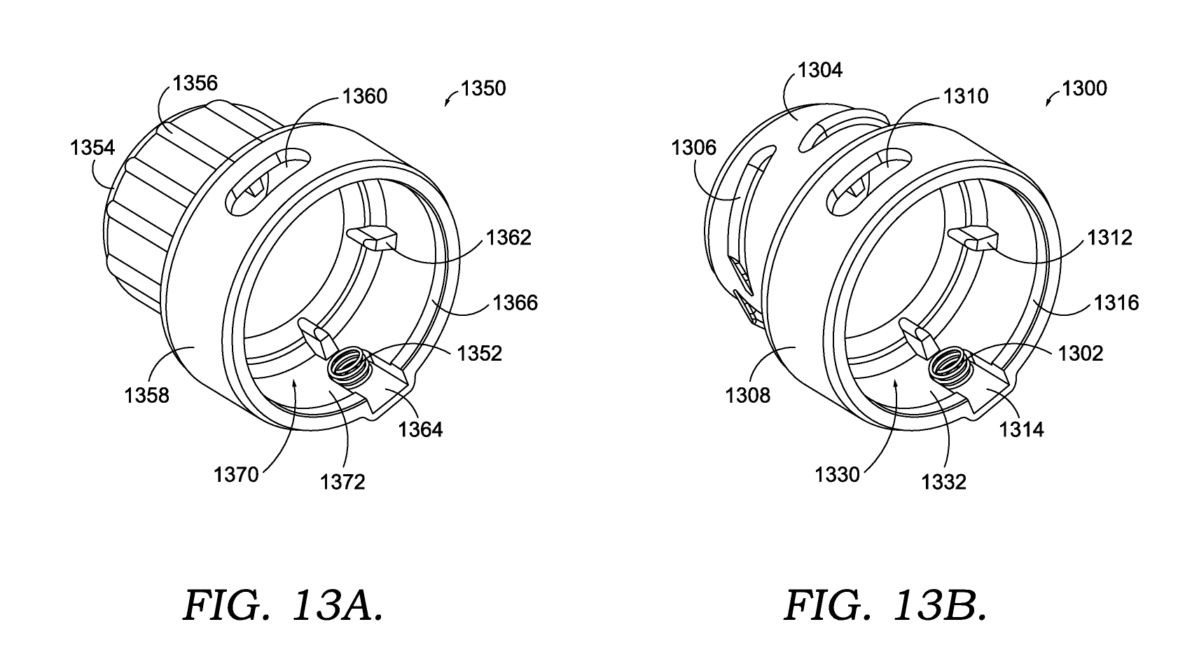

FIG. 12 shows another configuration for the ring portion 1200, in accordance with aspects herein. As shown, ring portion 1200 may comprise a tab portion 1202, a spring receiving groove 1204 located opposite the tab portion 1202, and a chalk gripping element 1206 located on an interior surface 1220 of the ring portion 1200. In other words, if the ring portion 1200 were to be bisected along a line 1212, the tab portion 1202 would be located on the external surface 1222 of the ring portion 1200 on one half 1224 of the ring portion 1200, and the spring receiving groove 1204 would be located on the external surface 1222 of the ring portion 1200 on the other half 1226, and aligned to be directly opposite to the tab portion 1202. Further, a thickness of the ring portion 1200 may become progressively wider toward the half 1226. In other words, the overall thickness 1216 of the ring portion 1200 of the first half 1224 is less than the thickness 1214 of the second half 1226, where the thickness is changed gradually. Further, as briefly described above, the width 1218 of the ring portion 1200 is determined based on how the ring is being stabilized inside of a sheltering portion of a second end cap, for example, the cavities 1370 and 1330, respectively, of the sheltering portions 1358 and 1308, respectively, shown in FIGS. 13A and 13B, respectively.

FIG. 13A, for instance, shows a second end cap 1350 generally comprising a spring 1352 disposed within a spring compartment 1364. Also shown is a tip portion 1354 having a plurality of ridges 1356 for securely stacking the stackable chalk dispensing devices, in accordance with aspects herein. Similar to the second end caps described above, the sheltering portion 1358 may comprise an opening 1360 for allowing the tab portion (e.g., 1202 in FIG. 12) of the ring portion (e.g., 1200 in FIG. 12) to extend through. As further described briefly above, the ring portion (e.g., 1200 in FIG. 12) needs to be stabilized within the cavity 1370 of the sheltering portion 1358. Therefore, as shown, the interior surface 1372 of the sheltering portion 1358 may be provided with at least one holder tab 1362 to prop up the ring portion (e.g., 1200) at the right location for interaction with the spring 1352. Further, the sheltering portion 1358 of the second end cap 1350 may also comprise a ledge 1366 on its interior surface 1372 to prevent, for example, the lip portion (e.g., 130 in FIG. 2B) of the housing portion (e.g., 120 in FIG. 2B) of the stackable chalk dispensing devices, in accordance with aspects herein, from sliding too far in and therefore tightening the ring portion (e.g., 1200 in FIG. 12) too much so as to prevent it from sliding from side to side when the tab portion (e.g., 1202 in FIG. 12) is pushed and released by a user.

Similar to FIG. 13A, FIG. 13B, for instance, shows a second end cap 1300 generally comprising a spring 1302 disposed within a spring compartment 1314. Also shown is a tip portion 1304 having one or more threading elements 1306 for securely stacking the stackable chalk dispensing devices vertically, in accordance with aspects herein. Similar to the second end caps described above, the sheltering portion 1308 may comprise an opening 1310 for allowing the tab portion (e.g., 1202 in FIG. 12) of the ring portion (e.g., 1200 in FIG. 12) to extend through. As further described briefly above, the ring portion (e.g., 1200 in FIG. 12) needs to be stabilized within the cavity 1330 of the sheltering portion 1308. Therefore, as shown, the interior surface 1332 of the sheltering portion 1308 may be provided with at least one holder tab 1312 to prop up the ring portion (e.g., 1200) at the right location for interaction with the spring 1302. Further, the sheltering portion 1308 of the second end cap 1300 may also comprise a ledge 1316 on its interior surface 1332 to prevent, for example, the lip portion (e.g., 130 in FIG. 2B) of the housing portion (e.g., 120 in FIG. 2B) of the stackable chalk dispensing devices in accordance with aspects herein, from sliding too far in and therefore tightening the ring portion (e.g., 1200 in FIG. 12) too much so as to prevent it from sliding from side to side when the tab portion (e.g., 1202 in FIG. 12) is pushed and released by a user.

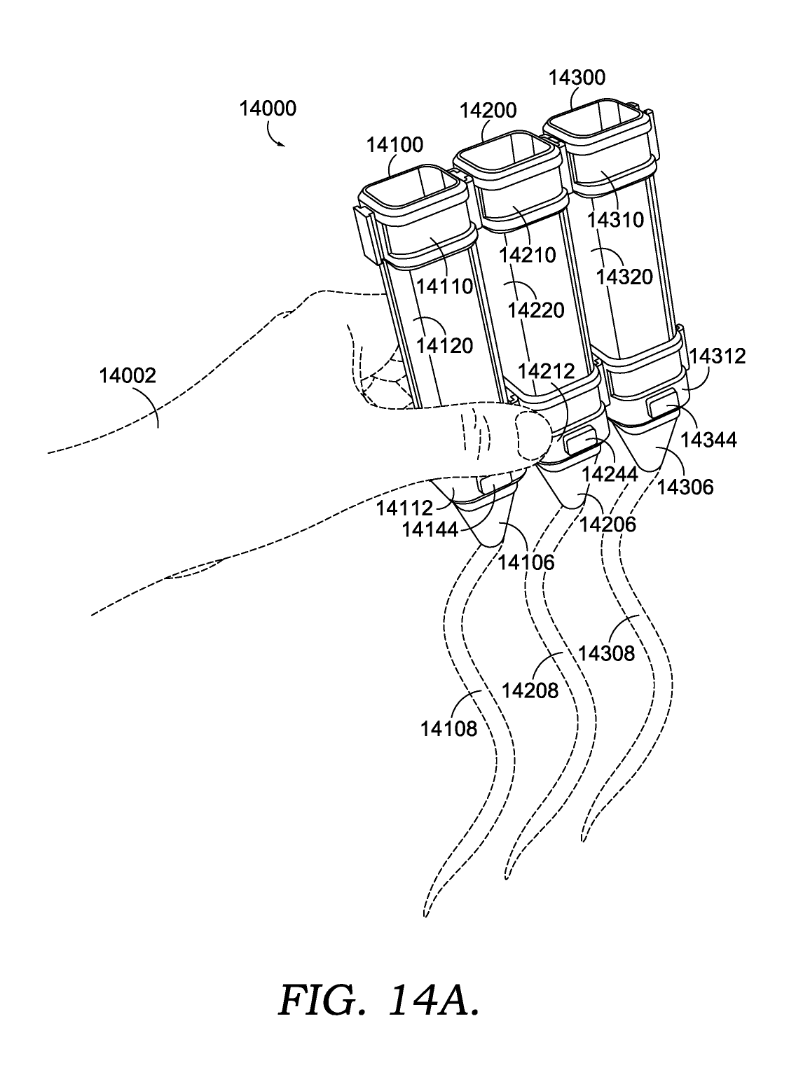

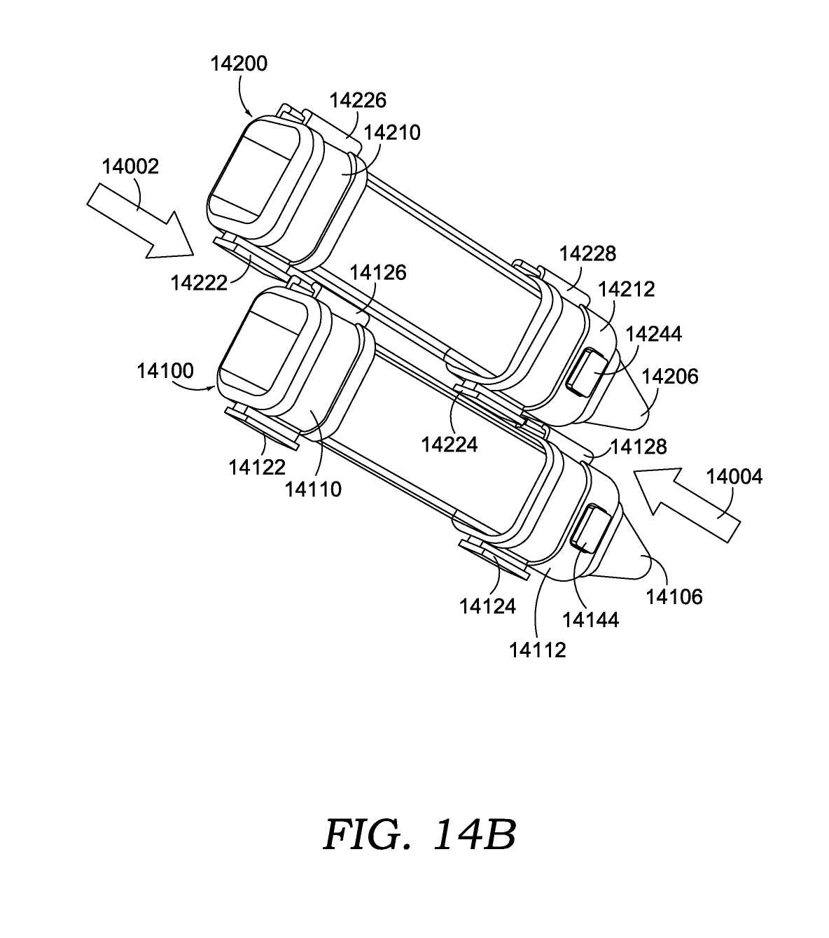

FIG. 14A depicts a hand 14002 of a user using a horizontal stack 14000 of stackable chalk dispensing devices, for example, 14100, 14200 and 14300. Although only three are shown in the horizontal stack, it is contemplated that more or less stackable chalk dispensing devices may be horizontally stacked according to the preferences of the user. Each of the stackable chalk dispensing devices 14100, 14200, and 14300 comprise a respective first end cap 14110, 14210, and 14310, a respective housing 14120, 14220, and 14320, and a respective second dispensing end cap 14112, 14212, and 14312. Each of the respective second dispensing end caps 14112, 14212, and 14312, as described above with respect to the vertically stacking stackable chalk dispensing devices, comprises a chalk holding/dispensing mechanism with a respective tab 14144, 14244, and 14344 for controlling the chalk holding/or releasing mechanism of each of the stackable chalk dispensing devices 14100, 14200, and 14300, respectively. As shown in FIG. 14A, the horizontal stack 1400 may be used for making multiple markings (e.g., 14108, 14208, 14308) on a receiving surface, simultaneously, by providing a chalk piece (e.g., 14106, 14206, 14306) in each stackable chalk dispensing device 14100, 14200 and 14300, respectively.

FIG. 14B depicts how the stackable chalk dispensing devices (e.g., 14100 and 14200), in accordance with aspects herein, may be stacked laterally or in a horizontal direction. For example, each of the end caps 14110, 14210, 14112, and 14212 may comprise a set of a sliding projection portion (e.g., 14122, 14124, 14222, and 14224) and an encasing bracket portion (e.g., 14126, 14128, 14226, and 14228). Specifically, as shown, the sliding projection portions 14122 and 14124 of the first stackable chalk dispensing device 14100 may be located on the same side of the first stackable chalk dispensing device 14100, while the encasing bracket portions 14126 and 14128 may be located on an opposite side to the sliding projection portions 14122 and 14124 of the first stackable chalk dispensing device 14100. However, this configuration is not set and, although the sliding projection portions (e.g., 14122, 14124, 14222, and 14224) will always be located on an opposite side to the encasing bracket portions (e.g., 14126, 14128, 14226, and 14228) of a respective end cap (e.g., 14110, 14112, 14210, and 14212), the sliding projection portion (e.g., 14122, 14222) of each of the first end caps (e.g., 14110 and 14210) may be on one side, while the projection portion (e.g., 14124, 14224) of each of the second end caps (e.g., 14112 and 14212) may be located on the same side as the projection portions (e.g., 14122, 14222) of the first end caps (e.g., 14110 and 14210) (as shown), or on the opposite side (not shown).

As further shown in FIG. 14B, the sliding projection portions 14222 and 14224 of one stackable chalk dispensing device, such as, stackable chalk dispensing device 14200 may slide into the encasing bracket portions 14126 and 14128 of another stackable chalk dispensing device, such as, stackable chalk dispensing device 14100. The sliding projection portions 14222 and 14224 may be slid into the encasing bracket portions 14126 and 14128 by properly aligning the sliding projection portions 14222 and 14224 and then applying a force in the direction of arrow 14002 or arrow 14004, which is generally orthogonal to the direction of growth of the horizontal stack, as two or more stackable chalk dispensing devices are stacked together, until the sliding projection portions 14222 and 14224 are level with the encasing bracket portions 14126 and 14128, respectively, as shown in FIG. 14A. When the stackable chalk dispensing devices (e.g., 14100 and 14200) are horizontally stacked, and when each one of them is provided with their own chalk piece (e.g., 14106 and 14206), a user is able to make chalk markings on a receiving surface simultaneously with for example, both chalk pieces 14106 and 14206, provided, as provided in FIG. 14B.

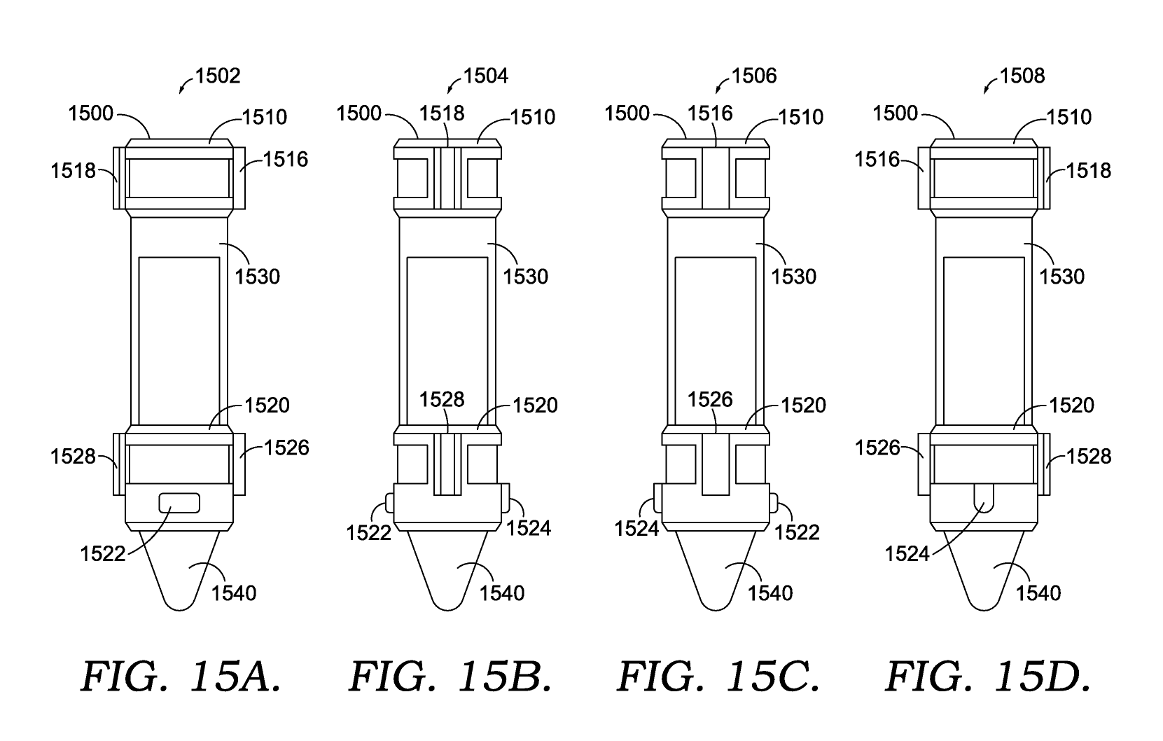

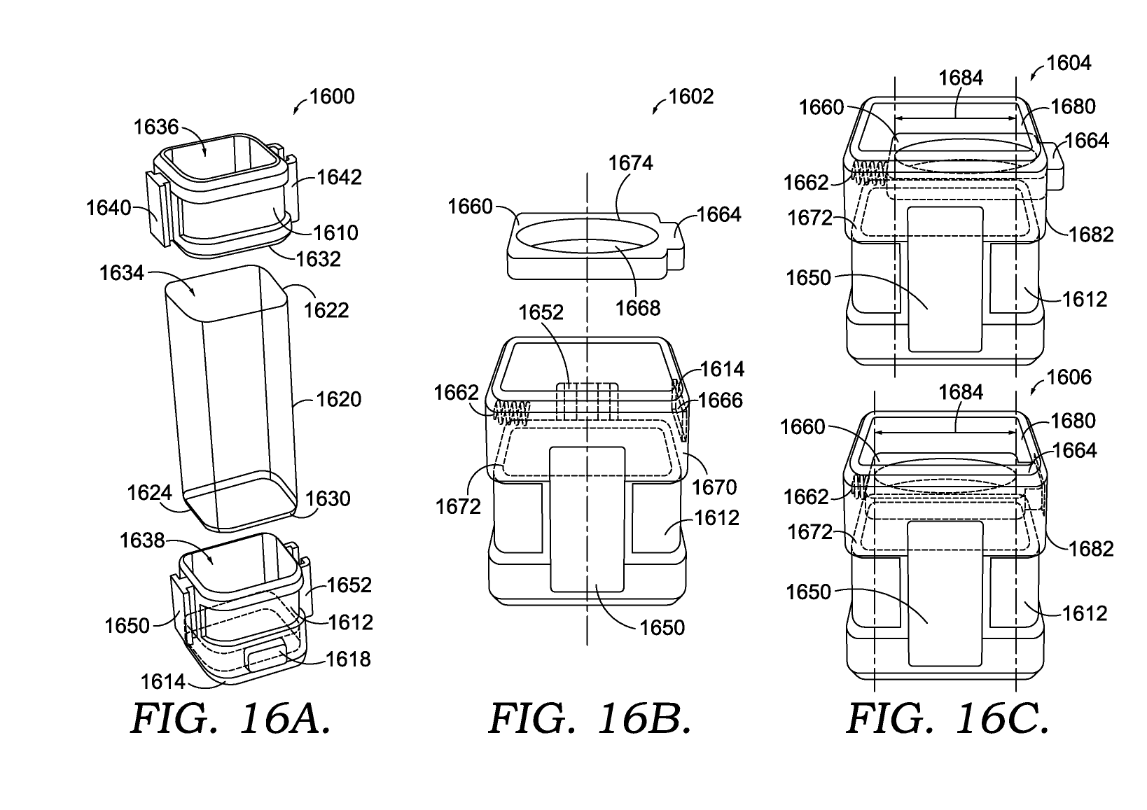

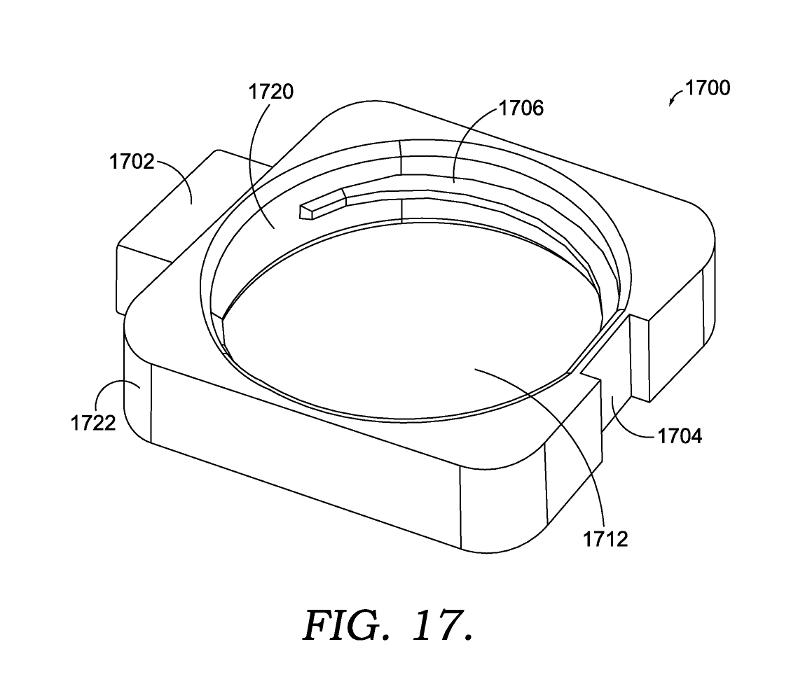

FIGS. 15A-15D depict different views of a stackable chalk dispensing device 1500. As shown, the stackable chalk dispensing device 1500 may have a cross-section with straight edges, such as a square, as opposed to a circular cross-section. It is also contemplated that many other cross-sectional shapes may be used such as, for example, hexagonal, triangular, oval, and the like. FIG. 15A depicts a frontal view of a first side 1502 of the stackable chalk dispensing device 1500 showing a frontal view of the tab portion 1522 for the holding/dispensing mechanism at the second end cap portion 1520 for holding or dispensing the chalk piece 1540. As shown, the first end cap 1510 comprises an encasing bracket portion 1518 on a second side 1504 of the stackable chalk dispensing device 1500, as shown in FIG. 15B, and a sliding projection portion 1516 on a third side 1506, as shown in FIG. 15C. Similarly, the second end cap portion 1520 comprises an encasing bracket portion 1528 on the second side 1504 of the stackable chalk dispensing device 1500, as also shown in FIG. 15B, and a sliding projection portion 1526 on the third side 1506, as also shown in FIG. 15C. However, this is only a configuration and it is also contemplated that the location of the sliding projection portion 1526 and the encasing bracket portion 1528 may be reversed on the second end cap, and still be within the scope of aspects herein. FIG. 15D depicts a frontal view of the fourth side 1508 of the stackable chalk dispensing device 1500. As shown, the holding/dispensing mechanism of the second end cap portion 1520 comprises a protrusion 1524 that forms a spring compartment on the interior of the second end cap portion 1520 for accommodating a spring that operates with the tab portion 1522 to hold and release the chalk piece 1540, as will become more apparent with reference to FIGS. 16A to 16C.

FIG. 16A depicts a deconstructed view of a horizontally stackable chalk dispensing device 1600. As briefly described above, the horizontally stackable chalk dispensing device 1600 comprises a first end cap 1610 having a receiving cavity 1636, a lip portion 1632, a sliding projection portion 1640, and an encasing bracket portion 1642, wherein the sliding projection portion 1640 is configured to be fitted with an encasing bracket portion of another stackable chalk dispensing device and, wherein the encasing bracket portion 1642 is configured to be fitted with a sliding projection portion of yet another stackable chalk dispensing device to make a horizontal stack. The lip portion 1632 is configured to be fitted with the first end 1622 of the housing portion 1620. The housing portion 1620 may also comprise a lip portion 1630 at the second end 1624 that may be configured to be fitted with the second end cap 1612. The housing portion 1620 is essentially a hollow tube having an enclosed cavity 1634. The second end cap 1612 is configured to shelter a holding/dispensing mechanism 1618 between the housing portion 1620 and the dispenser tip portion 1614. The second end cap 1612 also encloses a cavity 1638 and also comprises a sliding projection portion 1650 that may be on the same side or on the opposite side as sliding projection portion 1640, and an encasing bracket portion 1652 that may be on the same side or on the opposite side of encasing bracket portion 1642. Thus, when the first end cap 1610, the housing portion 1620, and the second end cap 1612 are assembled together, the cavities 1636, 1634, and 1638 are configured to form a single through cavity that allows a chalk piece (not shown) to be inserted, housed, and dispensed through an assembled horizontally stackable chalk dispensing device 1600, for example. Further, although not specifically shown, it is contemplated that the stackable chalk dispensing device may also be vertically stackable by providing the vertically stackable properties described above with reference to FIGS. 2A-2D and 7A-7D, for example, where the dispenser tip portion 1614 of the horizontally stackable chalk dispensing device 1600 may further comprise a plurality of ridges or threading elements that may secure the horizontally stackable chalk dispensing device 1600 with another stackable chalk dispensing device by, for instance, pushing the dispenser tip portion 1614 into the receiving cavity of the other stackable chalk dispensing device.

FIG. 16B depicts a deconstructed view 1602 of the second end cap 1612 having the dispenser tip portion 1614, and housing the holding/dispensing mechanism 1618 shown in FIG. 16A. As shown, the holding/dispensing mechanism 1618 is comprised of at least a ring portion 1660 and a spring 1662. The ring portion 1660 may be fitted with a tab portion 1664, or the tab portion 1664 may be integrally formed with the ring portion 1660 as a single piece. The ring portion 1660 may be formed from a rigid or semi-rigid material, and the tab portion 1664 may be configured to extend through an opening 1666 formed in the sheltering portion 1670 of the second end cap 1612. The sheltering portion 1670 may be provided with the spring 1662 at a location that is opposite to the opening 1666. The ring portion 1660 encloses an opening 1668 that may have an interior diameter/perimeter 1674 (depending on the shape of the opening 1668) that is smaller than interior perimeter 1672 of the sheltering portion 1670 to provide a working space for the spring 1662 when the ring portion 1660 is disposed within the sheltering portion 1670 with tab portion 1664 extended through opening 1666 of the sheltering portion 1670 of the second end cap 1612. Although not shown, for simplicity's sake, a set of supporting elements for supporting the ring portion 1660 may be provided on an interior surface of the sheltering portion 1670 to sustain the ring portion 1660 in place to stabilize it in the Y-direction while it is able to slide back and forth in the X-direction.

FIG. 16C depicts the holding/dispensing mechanism 1618, as shown in FIGS. 16A and 16B, of the horizontally stackable chalk dispensing device 1600 in action. For example, the 1600 perspective view 1604 shows the holding configuration for the holding/dispensing mechanism 1618, and the perspective view 1606 shows the dispensing configuration for the holding/dispensing mechanism 1618. As seen from the perspective view 1604, when the holding/dispensing mechanism 1618 is in its holding configuration, the spring 1662 is in its relaxed state (stretched) and is configured to push the ring portion 1660 so that the ring portion 1660 becomes pushed against the interior surface 1680 of the sheltering portion 1670 of the second end cap 1612. Consequently, the tab portion 1664 becomes exposed and is configured to protrude beyond the external surface 1682 of the sheltering portion 1670 of the second end cap 1612. As well, the through opening 1684 through the second end cap 1612 becomes constricted, and therefore, it exerts a holding force on a chalk piece (not shown) inserted into the horizontally stackable chalk dispensing device 1600, in accordance with aspects herein. Alternatively, when the holding/dispensing mechanism 1618 is in its dispensing configuration as shown in the perspective view 1606, a user pushes on the tab portion 1664. The pushing force essentially causes the ring portion 1660 to push against the spring 1662, causing it to contract and store the energy from the push. As well, the push on the tab portion 1664 causes the through opening 1684 of the ring portion 1660 and the interior perimeter 1672 of the dispenser tip portion 1614 to align and therefore release the chalk piece inserted into the horizontally stackable chalk dispensing device 1600 so that the chalk piece is able to sufficiently slide out of the horizontally stackable chalk dispensing device 1600 so that it becomes exposed and ready for use.

FIG. 17 shows another configuration for the ring portion 1700, in accordance with aspects herein. As shown, ring portion 1700 may comprise a tab portion 1702, a spring receiving groove 1704 located opposite the tab portion 1702, and a chalk gripping element 1706 located on an interior surface 1720 of the ring portion 1700. In other words, the tab portion 1702 would be located on the external surface 1722 of the ring portion 1700 and the spring receiving groove 1704 would be located on the external surface 1722 of the ring portion 1700 that is directly opposite to the tab portion 1702. Further, an opening 1712 of the ring portion 1700 may be circular in shape, as shown, or may be of any suitable shape such as square, triangle, hexagonal, and the like, not necessarily matching the overall shape of the ring portion 1700. Alternatively, the overall shape of the ring portion may be circular, as shown in FIG. 12, even though the shape of the body of the stackable chalk dispensing device may have straight edges.

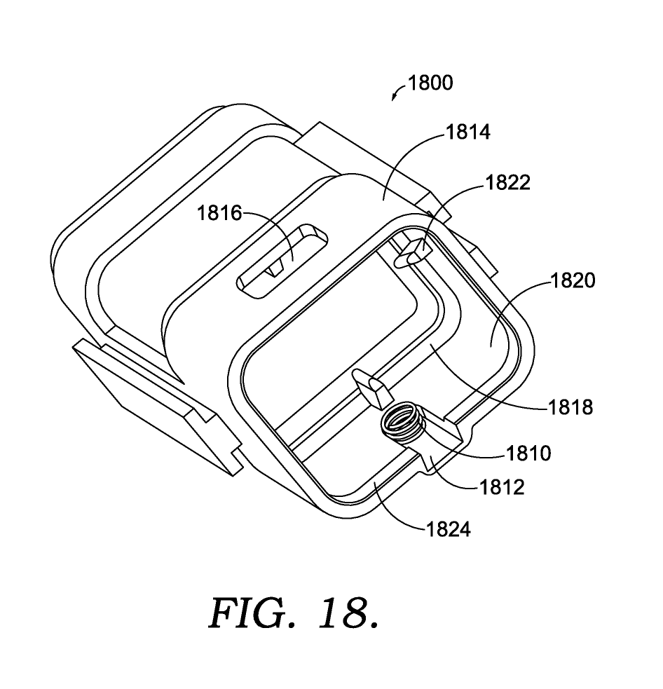

FIG. 18 shows a second end cap 1800 generally comprising a spring 1810 disposed within a spring compartment 1812. Similar to the second end caps described above, the sheltering portion 1814 may comprise an opening 1816 for allowing the tab portion (e.g., 1702 in FIG. 17) of the ring portion (e.g., 1700 in FIG. 17) to extend through. As further described briefly above, the ring portion (e.g., 1700 in FIG. 17) needs to be stabilized within the sheltering cavity 1818 of the sheltering portion 1814. Therefore, as shown, the interior surface 1820 of the sheltering portion 1814 may be provided with at least one holder/support tab 1822 to prop up the ring portion (e.g., 1700) at the right location for interaction with the spring 1810. Further, the sheltering portion 1814 of the second end cap 1800 may also comprise a ledge 1824 on its interior surface 1820 to prevent, for example, the lip portion (e.g., 1630 in FIG. 16A) of the housing portion (e.g., 1620 in FIG. 16A) of the horizontally stackable chalk dispensing device 1600, in accordance with aspects herein, from sliding too far in and therefore tightening the ring portion (e.g., 1700 in FIG. 17) too much so as to prevent it from sliding from side to side when the tab portion (e.g., 1702 in FIG. 17) is pushed and released by a user.

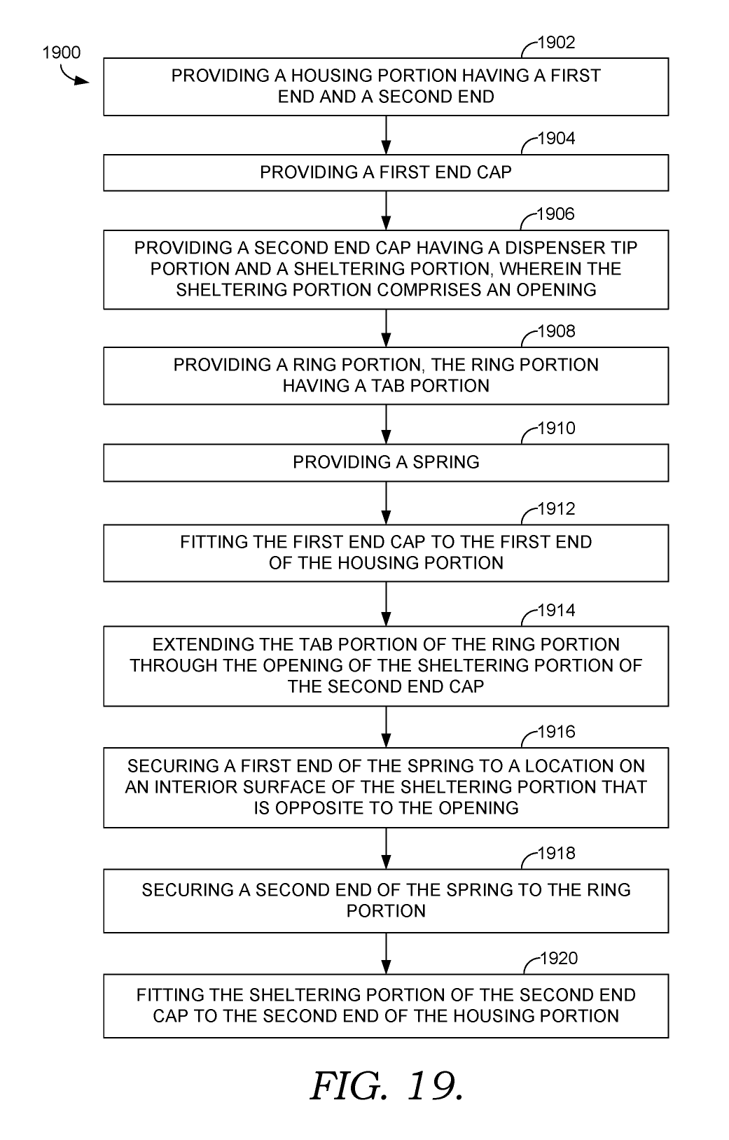

In a different aspect, FIG. 19 depicts a method 1900 for manufacturing the stackable chalk dispensing device, in accordance with aspects herein. The method 1900 may include providing a housing portion for the stackable chalk dispensing device as shown at step 1902, wherein the housing portion may be formed from a rigid or semi-rigid plastic material. The housing portion may be a see-through material or a clear (transparent glass-like material) that is in a tubular configuration. In particular, the housing portion may be formed from a break resistant synthetic polymer material, such as, for example, polyethylene terephthalate (PET) and the like. The method 1900 may further comprise providing a first end cap and a second end cap, as shown at steps 1904 and 1906, respectively. The first end cap is configured to be fitted to one end of the housing portion, and the second end cap is configured to be fitted to the other opposite end of the housing portion, as shown at step 1912. The second end cap may be provided with a holding/dispensing mechanism disposed within, where the holding/dispensing mechanism is comprised of a spring and a ring portion having a tab portion that may be configured to extend through an opening formed in the body of the sheltering portion of the second end cap. The ring portion and the spring may be provided, as shown at steps 1908 and 1910, and when assembling the second end cap, the ring portion may be inserted into the sheltering portion with its tab portion extending through the opening in the sheltering portion of the second end cap, as shown at step 1914. The spring may be permanently secured to an interior surface of the sheltering portion that is directly opposite to the opening, as shown at step 1916. Once the tab portion is inserted through the opening, the spring may be further secured to the surface that is directly opposite to the tab portion of the ring portion, as shown at step 1918. Therefore, the ring portion may be configured to move laterally by a user pushing on the tab portion or releasing the tab portion. Further, the second end cap may also be provided with a dispenser tip portion configured to protect and stabilize the chalk piece when in use. An internal diameter/perimeter of the ring portion and the tip portion may be configured to generally match and align when a user presses on the tab portion and become misaligned when the user releases the tab portion, causing them to misalign. Once the holding/dispensing mechanism is assembled in the sheltering portion of the second end cap, the housing portion may be fitted into the second end cap to seal the holding/dispensing mechanism in place, as shown at step 1920. Further, for the vertically stackable chalk dispensing devices, the dispenser tip portion of the second end cap may be provided with a plurality of ridges, or alternatively one or more threading elements, wherein the plurality of ridges or threading elements may serve to secure the stackable chalk dispensing devices in a stacked configuration when stacked. Complementary to the securing mechanism of the dispenser tip portion(s), the first end cap of the stackable chalk dispensing device(s), in accordance with aspects herein, may comprise a complementary receiving surface for the dispenser tips. Furthermore, for the horizontally stackable chalk dispensing devices, each end cap may be provided with respective sliding projection portions and respective encasing bracket portions. Additionally, in accordance with some aspects, a stackable chalk dispensing device may be provided with both the vertically stacking features and the horizontal stacking features, in accordance with aspects herein. The end caps may be permanently affixed to the housing portion of the stackable chalk dispensing device(s) by ultrasonic welding, by applying adhesives, or alternatively, they may simply be configured to fit tightly together without the need for permanent bonding. Both the first and second end caps, and the ring portion, may also be formed from a rigid or semi-rigid material, such as plastic, metal, wood, and the like. Further, these may be provided with color or may also be transparent or see-through, depending on the material used for their manufacture. It is to be noted that these steps may be performed in any order, and therefore, the sequence of events should not be construed as limiting, but as an example.

In accordance with further aspects herein, the stackable chalk dispensing device(s) may be provided in a kit. For example, the kit may include a set of one or more chalk pieces (e.g., two chalk pieces) and two stackable chalk dispensing devices. The stackable chalk dispensing devices may be provided with the same color scheme, or they may alternatively be differentiated by providing them with end caps of different colors. In other aspects, different kits of different sizes may be provided so that a user may be given the choice of how many stackable chalk dispensing devices he/she may want to stack. In accordance with other aspects, the chalk pieces and the stackable chalk dispensing devices may be provided separately. Alternatively, the stackable chalk dispensing devices may be customizable by, for example, allowing a user to pick the color of each of the components of a stackable chalk dispensing device (i.e., housing portion, first end cap, second end cap, and ring portion) and assembling the stackable chalk dispensing devices at the purchase site.

The aspects described throughout this specification are intended in all respects to be illustrative rather than restrictive. Upon reading the present disclosure, alternative aspects will become apparent to ordinary skilled artisans that practice in areas relevant to the described aspects without departing from the scope of this disclosure. In addition, aspects of this technology are adapted to achieve certain features and possible advantages set forth throughout this disclosure, together with other advantages which are inherent. It will be understood that certain features and subcombinations are of utility and may be employed without reference to other features and subcombinations. This is contemplated by and is within the scope of the claims.

Since many possible embodiments may be made of the technology described herein without departing from the scope thereof, it is to be understood that all matter herein set forth or shown in the accompanying drawings is to be interpreted as illustrative and not in a limiting sense.

The invention claimed is:

1. A stackable chalk dispensing device comprising:
a housing portion comprising a first terminal portion and a second terminal portion;
a first end cap fitted to the first terminal portion of the housing portion; and
a second end cap fitted to the second terminal portion of the housing portion, wherein the second end cap comprises a chalk holding/dispensing mechanism disposed within a sheltering portion of the second end cap.

2. The stackable chalk dispensing device of claim 1, wherein the sheltering portion of the second end cap comprises a first interior diameter/perimeter that is larger than a second interior diameter/perimeter of the dispenser tip portion.

3. The stackable chalk dispensing device of claim 2, wherein the chalk holding/dispensing mechanism comprises a spring, and a ring portion with a tab portion.

4. The stackable chalk dispensing device of claim 3, wherein when the spring is in a relaxed state, the spring is expanded, and wherein when the spring is in a loaded state, the spring is contracted.

5. The stackable chalk dispensing device of claim 4, wherein an interior diameter/perimeter of the ring portion is the same as the interior diameter/perimeter of the dispenser tip portion.

6. The stackable chalk dispensing device of claim 5, wherein the spring is secured to an interior surface of the sheltering portion, and wherein the ring portion is located within the sheltering portion with the tab portion extending through an opening in the sheltering portion.

7. The stackable chalk dispensing device of claim 6, wherein when the tab portion is pushed in by a user, the ring portion is configured to push the spring so that the spring becomes contracted and the interior diameter/perimeter of the ring portion and the interior diameter/perimeter of the dispenser tip portion become aligned with each other.

8. The stackable chalk dispensing device of claim 7, wherein when the tab portion is released by the user, the spring is configured to push the ring portion so that the tab portion is pushed out and the interior diameter/perimeter of the dispenser tip portion and the interior diameter/perimeter of the ring portion become misaligned with each other.

9. The stackable chalk dispensing device of claim 8, wherein when the interior diameter/perimeter of the dispenser tip portion and the interior diameter/perimeter of the ring portion become misaligned, a chalk piece provided within the stackable chalk dispensing device is held in place.

10. The stackable chalk dispensing device of claim 9, wherein when the diameter/perimeter of the dispenser tip portion and the interior diameter/perimeter of the ring portion become aligned, a chalk piece provided within the stackable chalk dispensing device is released.

11. The stackable chalk dispensing device of claim 1, wherein the dispenser tip portion comprises one or more threading elements on its outer surface for securing the stackable chalk dispensing device to a first end cap of another stackable chalk dispensing device.

12. The stackable chalk dispensing device of claim 1, wherein the dispenser tip portion comprises a plurality of ridges on its outer surface for securing the stackable chalk dispensing device to a first end cap of another stackable chalk dispensing device.

13. The stackable chalk dispensing device of claim 1, wherein each of the first end cap and the second end cap comprises a sliding projection portion and an encasing bracket portion.

14. A method of assembling a stackable chalk dispensing device comprising:
providing a housing portion having a first end and a second end;
providing a first end cap;
providing a second end cap having a dispenser tip portion and a sheltering portion, wherein the sheltering portion comprises an opening;
providing a ring portion, the ring portion having a tab portion;
providing a spring;
fitting the first end cap to the first end of the housing portion;
extending the tab portion of the ring portion through the opening of the sheltering portion of the second end cap;
securing a first end of the spring to a location on an interior surface of the sheltering portion that is opposite to the opening;
securing a second end of the spring to the ring portion; and
fitting the sheltering portion of the second end cap to the second end of the housing portion.

15. The method of claim 14, wherein the housing portion is formed from a clear or see-thorough rigid or semi-rigid material.

16. The method of claim 14, wherein the first end cap and the second end cap are formed from a rigid or semi-rigid material.

17. The method of claim 16, wherein the rigid or semi-rigid material comprises one of plastic, metal, or wood.

18. A stackable chalk dispensing device comprising:
a housing portion comprising a first terminal portion and a second terminal portion;
a first end cap, wherein a first end of the first end cap comprises a receiving cavity for receiving a dispenser tip portion of a second stackable chalk dispensing device, and wherein the first end cap is fitted to the first terminal portion of the housing portion; and
a second end cap, wherein the second end cap comprises a spring-loaded chalk holding/dispensing mechanism and a dispenser tip portion, wherein the second end cap is fitted to the second terminal portion of the housing portion, and wherein the spring-loaded chalk holding/dispensing mechanism comprises a spring, and a ring portion with a tab portion.

19. The stackable chalk dispensing device of claim 18, wherein the spring, and the ring portion are located within a sheltering portion of the second end cap, wherein the tab portion extends through an opening in the sheltering portion located opposite to the spring, and wherein the spring is secured to an interior surface of the second end cap.

20. The stackable chalk dispensing device of claim 19, wherein when the tab portion is pushed in a first direction, the ring portion is configured to push the spring so that the spring becomes contracted in a dispense mode of the stackable chalk dispensing device, and wherein when the tab portion is released, the spring is configured to push the ring portion in a second opposite direction so that the tab portion is pushed out in a hold mode of the stackable chalk dispensing device.
